(19) United States
(12) Patent Application Publication
(10) Pub. No.: US 2021/0398446 A1
(43) Pub. Date: Dec. 23, 2021

(54) System and Method for Teaching a Student How to Write using a Phonetic Word Distinction Technique

(71) Applicant: Unique Teach Holdings LLC, Houston, TX (US)

(72) Inventor: Mia Shimaj, Houston, TX (US)

(21) Appl. No.: 16/946,422

(22) Filed: Jun. 19, 2020

Related U.S. Application Data
(63) Continuation of application No. 16/946,419, filed on Jun. 19, 2020.

(51) Int. Cl. G09B 19/00; G09B 5/02; G09B 1/32

(52) U.S. Cl. CPC G09B 19/00; G09B 1/32; G09B 5/02

(57) ABSTRACT

A system and method for teaching a student how to write using a phonetic word distinction technique is herein disclosed. The method can comprise the step of providing to a student a set of charted grapheme-phoneme pairs, communicating to a student each word in a story in order of the story, in any manner other than a written form of the word, prompting the student to encode a phoneme of the set of phonemes with a grapheme, receiving first selections of the graphemes to form a set of graphemes in the order, and displaying in the order the graphemes associated with the first selections. Each word is a phonetic word if all grapheme-phoneme pairs between the spoken word of the word and a conventional spelling of the word each match at least one charted grapheme-phoneme pair within the set of charted grapheme-phoneme pairs, and a non-phonetic word if not.

### BACKGROUND

This disclosure relates to a system and method for teaching a student how to read using a vowel priming method. Reading is one of the most important skills that a child learns in life. The method of how a child learns to read can be an important factor that can determine the success of learning such skill. One known method of reading can be through the memorization and recognition of words, such as by using flashcards. This method of sight-reading allows the child recognize the words by memorizing the form of the word, or what the word looks like. A back-up strategy to this method is for a child to use the pictures in storybooks as a way to guess at unknown words. These two methods can be effective for a novice or a beginner reader. However, in the long run these two methods are sometimes ineffective in teaching a child how to properly sound out words. One common method of reading involves the child using letter-sound knowledge. This method involves learning the sounds of each letter of the conventional English alphabet chart and then teaching the child to read by breaking the words into these letter sounds. In this method, the child decodes words by starting at the beginning of the word and saying each letter sound individually and then combining the sounds to form the word. For example, a child reads the word dog by decoding the word as d-o-g and then combining the individual sounds to form the word “dog.” This method can be one of the most effective methods of teaching reading however there can be cumbersome in that it can involve several repetitions of the individual sounds of a word (d-o-g) in order to blend. Thus, this method of decoding may be mentally draining for young children when reading longer words. Children find it easier to resort back to the other two methods, the recognition method of reading words by sight and/or using of pictures to guess at unknown words. As such, it would be useful to have an improved system and method for teaching a student to read using the vowel priming method.

This disclosure further relates to a system and method for teaching a student to write using a plurality of charts. When learning to write in language, particularly English, phonemes can often be represented with more than one letter or grapheme. Similarly, a single grapheme can often represent more than one phoneme. A student is often left to memorization when learning how to write, making learning to write difficult. As such, it would be useful to have an improved system and method for teaching a student to write using a plurality of charts.

### SUMMARY

A system and method for teaching a student how to read using a vowel priming method is described herein. The method can comprise the step of displaying to a student a vowel grapheme of a set of graphemes while remaining graphemes of the set of graphemes are hidden. The remaining graphemes can each be represented by a generic symbol. The set of graphemes can be arranged such that when completely unhidden together can graphically construct a word. Further each grapheme of the set of graphemes encodes a phoneme. Each of the phonemes can be associated with the set of graphemes that together can be a set of phonemes. The set of phonemes together can audibly construct the word. The method can also comprise the steps of pausing to allow the student to determine the phoneme associated with the vowel grapheme, and revealing, after displaying the vowel grapheme, the remaining graphemes in one or more subsets of graphemes. Each subset can comprise one or more graphemes. The remaining graphemes can be revealed in order from a beginning of the word to an end of the word. Moreover, the method can comprise the step of pausing after each revelation to allow the student to determine one or more of the phonemes associated with the subset of graphemes revealed in the revelation.

In another embodiment, the system for teaching a student how to read using a vowel priming method can comprise a memory and a processor. The memory can comprise a learning application and a data store. The data store can comprise a set of graphemes and a generic symbol. Each grapheme of the set of graphemes encodes a phoneme. Each of the phoneme can be associated with the set of graphemes together can be a set of phonemes. The set of phonemes together can audibly construct a word. The processor can, according to instructions from the learning application display to a student on a screen a vowel grapheme of the set of graphemes while remaining graphemes of the set of graphemes are hidden. The remaining graphemes can each be represented by a generic symbol. The set of graphemes can be arranged such that when all of the graphemes are unhidden, the set of graphemes together can graphically construct the word. Moreover, according to the instructions from the learning application, the processor can pause to allow the student to determine the phoneme associated with the vowel grapheme, and can reveal, after displaying the vowel grapheme, the remaining graphemes in one or more subsets of graphemes. Each subset can comprise one or more graphemes. The remaining graphemes can be revealed in order from a beginning of the word to an end of the word. Lastly, according to the instructions from the learning application, the processor can pause after each revelation to allow the student to determine one or more of the phonemes associated with the subset of graphemes revealed in the revelation.

In another embodiment a method of teaching a user how to write using a plurality of chart is described herein. The method can comprise the step of communicating a word to a student in any manner other than a written form of the word. The spoken word of the word can comprise a set of phonemes in an order such that when the set of phonemes is spoken, the set of phonemes form the spoken word. The method can also comprise the step of prompting the student to encode each phoneme of the set of phonemes with a grapheme. The encoding performed by the student can be selecting the grapheme from a first plurality of graphemes. The first plurality of graphemes can be associated with a first chart. The first plurality of graphemes missing one or more necessary graphemes to form a conventional spelling of the word. Furthermore, the method can comprise the steps of receiving first selections of the graphemes to form a set of graphemes in the order and displaying in the order the graphemes that can be associated with the first selections. The set of graphemes can form an unconventional spelling of the word.

In another embodiment, system for teaching a student how to write using a plurality of chart is herein disclosed. The system can comprise a memory and a processor. The memory can comprise a learning application and data store. The data store can comprise a first chart, a plurality of phonemes associated with the first chart, a first plurality of graphemes associated with the first chart, and a set of phonemes. The first plurality of graphemes each can be a graphical representation of one or more of the plurality of phonemes. The first plurality of graphemes can be missing one or more necessary graphemes to form a conventional spelling of the word. Each phoneme of the set of phonemes can be from the plurality of phonemes. The set of phonemes can be in an order such that when the set of phonemes is spoken, the set of phonemes form a spoken word of a word. The processor can, according to instructions from the learning application communicate the word to a student in any manner other than a written form of the word, and prompts the student to encode each of the phonemes with a grapheme. The encoding performed by the student by selecting the grapheme from the first plurality of graphemes. The first plurality of graphemes associated with a first chart. Furthermore, the processor can, according to instructions from the learning application receive first selections of graphemes, to form a set of graphemes in the order, and displays in the order the graphemes associated with the first selections. The set of graphemes can form an unconventional spelling of the word.

In another embodiment, a method of teaching a child to read using a phonetic word distinction is herein disclosed. The method can comprise the step of providing to a student a set of charted grapheme-phoneme pairs. The set of charted grapheme-phoneme pairs can comprise a set of charted phonemes, and for each charted phoneme of the set of charted phonemes, one or more sets of charted graphemes can be associated with the charted phoneme. Each charted grapheme that can be within the one or more charted graphemes together with the charted phoneme can be a grapheme-phoneme pair of the set of charted grapheme-phoneme pairs. The method can also comprise the step of presenting to the student words in a story in order of the story. Each of the word being a phonetic word if all grapheme-phoneme pairs between a spoken word of the word and a conventional spelling of the word each match at least one charted grapheme-phoneme pair within the set of charted grapheme-phoneme pairs, and a non-phonetic word if not. The story can comprise one or more of the phonetic words and one or more of the non-phonetic words. The words in the story can be presented as follows, for each of the phonetic word, the method can comprise the step of displaying a first subset of graphemes of a set of graphemes while remaining graphemes of the set of graphemes are hidden. The set of graphemes can be arranged such that when each grapheme of the set of graphemes is unhidden, the set of graphemes together can graphically construct the phonetic word. Further, the first subset of grapheme can comprise one or more of the graphemes. Further each of the grapheme of the set of graphemes can encode a phoneme. All of the phonemes can be encoded by the graphemes of the set of graphemes together a set of phonemes. The set of phonemes together can audibly construct the phonetic word. Further, each of the phonemes can match one or more of the set of charted phonemes. Each of the graphemes can match one or more of the charted graphemes. Moreover, the method can comprise the steps of pausing to allow the student to decode a first subset of phonemes encoded with the first subset of graphemes, and revealing, after displaying the first subset of graphemes, the remaining graphemes in one or more subsets of graphemes. Each of the subset of graphemes can comprise one or more of the graphemes. Additionally, the method can comprise the step of pausing after each revelation to allow the student to decode a subset of phonemes associated with the subset of graphemes revealed in the revelation. Furthermore, for each of the non-phonetic word, the method can comprise the step of displaying all letters of the non-phonetic word contemporaneously.

In another embodiment, a system for teaching a student how to read using a phonetic word distinction technique is herein disclosed. The system can comprise a memory and a processor. The memory can comprise a learning application, and a data store. The data store can comprise a set of charted grapheme-phoneme pairs and a story. The set of charted grapheme-phoneme pairs can comprise a set of charted phonemes, and for each charted phoneme of the set of charted phonemes, one or more sets of charted graphemes can be associated with the charted phoneme. Each charted grapheme within the one or more charted graphemes together with the charted phoneme can be a grapheme-phoneme pair of the set of charted grapheme-phoneme pairs. The story can comprise a plurality of words. Each word of the plurality of words being a phonetic word if all grapheme-phoneme pairs between a spoken word of the word and a conventional spelling of the word each match at least one charted grapheme-phoneme pair within the set of charted grapheme-phoneme pairs, and a non-phonetic word if not. The story can comprise one or more of the phonetic words and one or more of the non-phonetic words. The processor can, according to instructions from the learning application presents to the student the words in the story in order of the story, wherein each of the phonetic word and the non-phonetic word is presented as follows, displaying a first subset of graphemes of a set of graphemes while remaining graphemes of the set of graphemes are hidden. The set of graphemes can be arranged such that when each grapheme of the set of graphemes is unhidden, the set of graphemes together can graphically construct the phonetic word. Further, the first subset of grapheme can comprise one or more of the graphemes. Further each of the grapheme of the set of graphemes can encode a phoneme. All of the phonemes encoded by the graphemes of the set of graphemes together can be a set of phonemes. The set of phonemes together can audibly construct the phonetic word. Further each of the phonemes can match one or more of the set of charted phonemes. Further each of the graphemes can match one or more of the charted graphemes. Moreover, wherein the method of presenting to the student the word can also comprise the steps of pausing to allow the student to decode a first subset of phonemes encoded with the first subset of graphemes, revealing, after displaying the first subset of graphemes, the remaining graphemes in one or more subsets of graphemes, pausing after each revelation to allow the student to decode a subset of phonemes associated the subset of graphemes revealed in the revelation, and for each of the non-phonetic word, displaying all letters of the non-phonetic word contemporaneously. Each of the subset of graphemes can comprise one or more of the graphemes.

In another embodiment a method of teaching a student how to write using a phonetic word distinction technique is herein disclosed. The method can comprise the step of providing to a student a set of charted grapheme-phoneme pairs. The set of charted grapheme-phoneme pairs can comprise a set of charted phonemes, and for each charted phoneme of the set of charted phonemes, one or more sets of charted graphemes can be associated with the charted phoneme. Each charted grapheme can be within the one or more charted graphemes together with the charted phoneme a grapheme-phoneme pair of the set of charted grapheme-phoneme pairs. The method can also comprise the step of communicating to a student each word in a story in order of the story, in any manner other than a written form of the word. The spoken word of the word can comprise a set of phonemes in the order such that when the set of phonemes is spoken, the set of phonemes form the spoken word. Each of the word can be a phonetic word if all grapheme-phoneme pairs between a spoken word of the word and a conventional spelling of the word can each match at least one charted grapheme-phoneme pair within the set of charted grapheme-phoneme pairs, and a non-phonetic word if not. The story can comprise one or more of the phonetic words and one or more of the non-phonetic words. The method can also comprise the steps of prompting the student to encode each phoneme of the set of phonemes with a grapheme, receiving first selections of the graphemes to form a set of graphemes in the order, and displaying in the order the graphemes associated with the first selections. The set of graphemes forming a spelling of the word. The encoding performed by the student by selecting the grapheme from a first plurality of graphemes. The first plurality of graphemes can be from the charted graphemes. For the non-phonetic word spelled with an unconventional spelling using the first plurality of graphemes, the method can comprise the steps of removing from display each of the grapheme incongruent with the conventional spelling of the non-phonetic word. Each of the phonemes previously encoded with a removed grapheme being no longer encoded. Furthermore, for non-phonetic word, the method can also comprise the steps of prompting the student to encode each of the phoneme no longer encoded, by selecting one or more replacement letters not representing a grapheme family member of the removed grapheme, receiving the one or more replacement letter selections, and displaying in place of each of the removed grapheme the one or more letters, forming the conventional spelling of the word.

In another embodiment, a system for teaching a student how to write using a phonetic word distinction technique is herein disclosed. The system can comprise a memory and a processor. The memory can comprise a learning application and a data store. The data store can comprise a set of charted grapheme-phoneme pairs and a story. The set of charted grapheme-phoneme pairs together can comprise a set of charted phonemes, and for each charted phoneme of the set of charted phonemes, one or more sets of charted graphemes can be associated with the charted phoneme. Each charted grapheme can be within the one or more charted graphemes together with the charted phoneme a grapheme-phoneme pair of the set of charted grapheme-phoneme pairs. The story can comprise a plurality of words. Each word of the plurality of words being a phonetic word if all grapheme-phoneme pairs between a spoken word of the word and a conventional spelling of the word each match at least one charted grapheme-phoneme pair within the set of charted grapheme-phoneme pairs, and a non-phonetic word if not. The story can comprise one or more of the phonetic words and one or more of the non-phonetic words. The processor can, according to instructions from the learning application communicates to a student each word in a story in order of the story, in any manner other than a written form of the word. The spoken word of the word comprising a set of phonemes in an order such that when the set of phonemes is spoken, the set of phonemes form the spoken word. Each of the word being a phonetic word if all grapheme-phoneme pairs between a spoken word of the word and a conventional spelling of the word each match at least one charted grapheme-phoneme pair within the set of charted grapheme-phoneme pairs, and a non-phonetic word if not. The story can comprise one or more of the phonetic words and one or more of the non-phonetic words. Furthermore, the processor can, according to the instructions of learning application prompt the student to encode each phoneme of the set of phonemes with a grapheme, receives first selections of the graphemes, to form a set of graphemes in the order, and displays in the order the graphemes associated with the first selections. The set of graphemes forming a spelling of the word. The encoding performed by the student by selecting the grapheme from a first plurality of graphemes. The first plurality of graphemes from the charted graphemes. For the non-phonetic word spelled with an unconventional spelling using the first plurality of graphemes, the method can comprise the steps of removing from display each of the grapheme incongruent with the conventional spelling of the non-phonetic word. Each of the phonemes previously encoded with a removed grapheme being no longer encoded. Furthermore, for non-phonetic word, the method can also comprise the steps of prompting the student to encode each of the phoneme no longer encoded, by selecting one or more replacement letters not representing a grapheme family member of the removed grapheme, receiving the one or more replacement letter selections, and displaying in place of each of the removed grapheme the one or more letters, forming the conventional spelling of the word.

In another embodiment, a non-transitory computer readable storage medium having a computer readable program code is herein disclosed. The computer readable program code can be adapted to be executed to implement the method disclosed above

### BRIEF DESCRIPTION OF THE DRAWINGS

FIG. 1A illustrates one embodiment of a learning system.

FIG. 1B illustrates a typical networking environment.

FIG. 1C illustrates an electronic device comprising a local memory and a local processor.

FIG. 1D illustrates a server comprising a server memory and a server processor.

FIG. 2 illustrates a data store comprising a student account, one or more stories, and one or more phoneme sets.

FIG. 3A illustrates an exemplary data model of a first phoneme set of phonemes.

FIG. 3B illustrates a first chart of charts illustrating a first phoneme set.

FIG. 3C illustrates an exemplary data model of a second phoneme set of phonemes.

FIG. 3D illustrates a second chart of a second phoneme set illustrating phonemes having more than one grapheme.

FIG. 3E illustrates an exemplary data model of a third phoneme set of phonemes.

FIG. 3F illustrates a third chart of a third phoneme set illustrating phonemes having more than one grapheme.

FIG. 3G illustrates a set of charted grapheme-phoneme pair.

FIG. 4 illustrates a reading routine embodiment.

FIG. 5A-5I together illustrates a three-step vowel priming method within a reading routine using graphemes from a first chart.

FIG. 5A illustrates decoding a word consisting of one phoneme, within a three-step vowel priming method of reading routine.

FIG. 5B illustrates using cards to perform methods described herein.

FIG. 5C illustrates revealing a middle-vowel grapheme in a three-step vowel-priming method.

FIG. 5D illustrates revealing a remaining grapheme at the beginning of a word, in a three-step vowel priming method.

FIG. 5E illustrates revealing a remaining grapheme at the end of a word, in a three-step vowel priming method.

FIG. 5F illustrates revealing a middle vowel grapheme of another word.

FIG. 5G illustrates a reading routine capable of offering assistance.

FIG. 5H illustrates revealing a grapheme at the beginning of another word, in a three-step vowel priming method.

FIG. 5I illustrates a revealing a consonant grapheme at the end of a word, in a three-step vowel priming method

FIG. 6A-6E together illustrate a two-step vowel priming method.

FIG. 6A illustrates decoding a word consisting of one phoneme, within a two-step vowel priming method of a reading routine.

FIG. 6B illustrates revealing middle-vowel phoneme in a two-step vowel priming method.

FIG. 6C illustrates revealing the beginning and ending consonant grapheme in a two-step vowel priming method.

FIG. 6D illustrates revealing middle vowel grapheme of a word in a two step-vowel priming method.

FIG. 6E illustrates revealing the beginning and ending consonant grapheme of a third word as part of a two-step vowel priming method.

FIG. 7A-7M illustrates a story within a reading routine illustrating more advanced techniques in a vowel-priming method, using grapheme from a plurality of charts.

FIG. 7A illustrates a story beginning with a word consisting of one phoneme.

FIG. 7B-7C illustrates an r-controlled vowel method.

FIG. 7B illustrates a first step in one embodiment of an r-controlled vowel method.

FIG. 7C illustrates an embodiment of a second word completely revealed.

FIGS. 7D-7F illustrate another method for revealing graphemes that starts with a vowel phoneme.

FIG. 7D illustrates a method for revealing graphemes that start with a vowel phoneme.

FIG. 7E illustrates a next step in a method for revealing graphemes that starts with a vowel phoneme .

FIG. 7F illustrates a word that starts with a vowel phoneme completely revealed.

FIG. 7G-7H illustrate decoding a sixth word, sixth word comprising a root word and a suffix.

FIG. 7G illustrates revealing a word comprising a root word and a suffix.

FIG. 7H illustrates revealing a suffix “ed” of a seventh word.

FIG. 7I illustrates a non-phonetic word.

FIG. 7J-7M illustrates decoding a compound word.

FIG. 7J illustrates revealing a grapheme representing a middle-vowel phoneme of a first word of a compound word.

FIG. 7K illustrates revealing graphemes representing consonant phonemes of a first word.

FIG. 7L illustrates revealing a grapheme representing a vowel phoneme of a second word of a compound word.

FIG. 7M illustrates revealing graphemes representing consonant phonemes of a second word.

FIG. 8A-8D illustrates a method of teaching to write a phonetic word using a first chart.

FIG. 8A illustrates encoding a phoneme of a phonetic word in an example of an embodiment of a writing routine,

FIG. 8B illustrates encoding another phoneme in a word.

REPLACEMENT 216-0019US

FIG. 8C illustrates encoding the final phoneme in a word.

FIG. 8D illustrates a word completely encoded using graphemes from a first chart.

FIG. 8E-8F illustrates additional method steps of the method of teaching the student to write a phonetic word using an additional chart.

FIG. 8E illustrates removing a grapheme incongruent with the conventional spelling of a phonetic word.

FIG. 8F illustrates incongruent grapheme “a” replaced with the appropriate replacement grapheme “ay” for conventional spelling.

FIG. 9A-9D illustrates a method of teaching to write a non-phonetic word.

FIG. 9A illustrates encoding a phoneme of a non-phonetic word in an example of an embodiment of a writing routine.

FIG. 9B illustrates encoding phonemes in a word.

FIG. 9C-9D illustrates the additional steps of the method of teaching the student to write non-phonetic word.

FIG. 9C illustrates removing a grapheme that is incongruent with the conventional spelling of a non-phonetic word.

FIG. 9D illustrates incongruent grapheme “u” replaced with one or more replacement letters for each removed grapheme.

FIG. 10 illustrates an exemplary method of teaching a student how to read using a vowel priming method.

FIG. 11 illustrates an exemplary method of teaching a student how to write using a plurality of charts.

FIG. 12 illustrates an exemplary embodiment of teaching a student to read using a phonetic word distinction technique.

FIG. 13 illustrates an exemplary embodiment of teaching a student to write using a phonetic word distinction technique.

### DETAILED DESCRIPTION

Described herein is a system and method for teaching a student how to read using a vowel priming method.

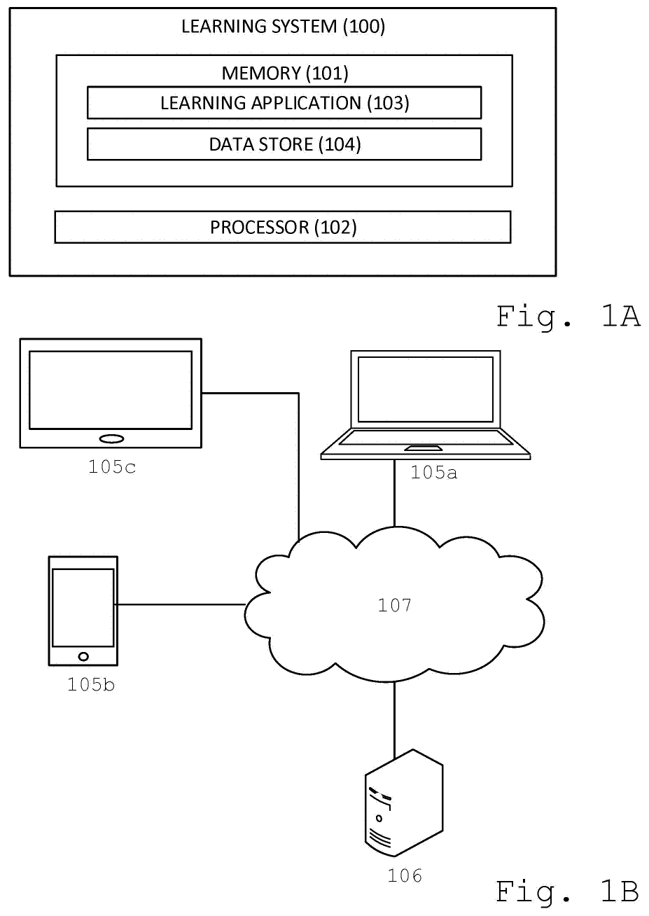

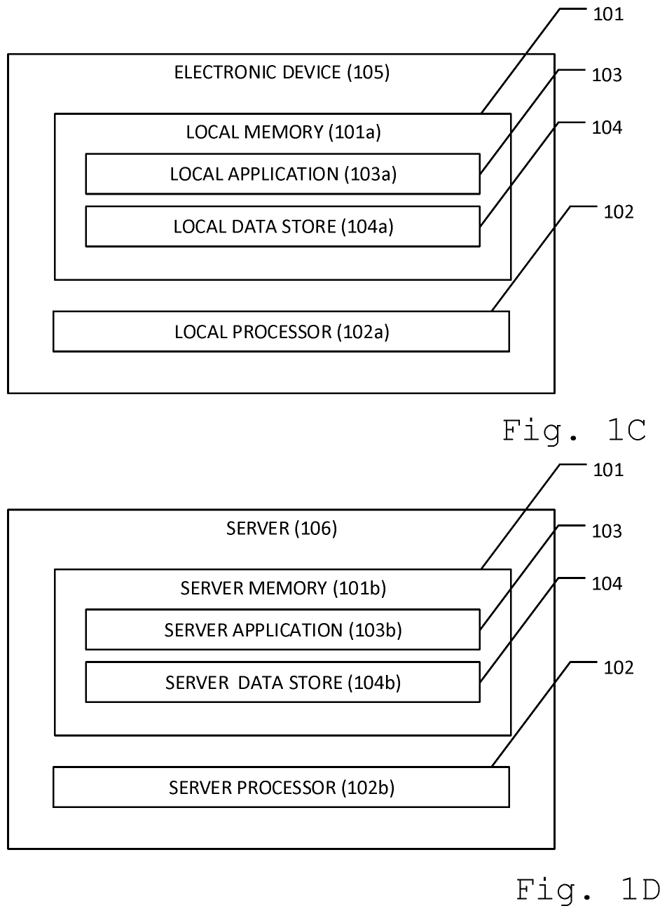

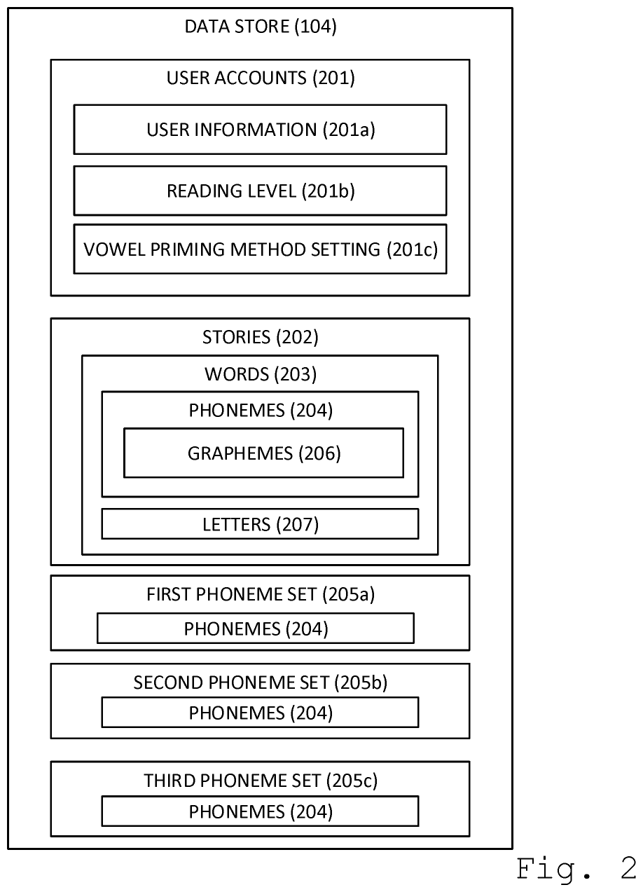

FIG. 1A illustrates one embodiment of a learning system 100. Learning system 100 can teach a person to read. Generally speaking, learning system 100 can teach a person to decode words starting with a vowel first, thus often guiding a student to start reading in the middle of a word instead of at the beginning of a word. Then the person can add on the consonants of the words, revealing the consonants from left to right. Such process is referred to in this disclosure as a vowel priming method. A vowel priming method can allow the student to decode words phonetically and can limit the need to memorize and recognize words. Further, a vowel priming method can allow a person such as a young child, who has limited mental resources, to decode and blend words more easily. A vowel priming method can also help a dyslexic person because rather than being presented with an entire word to decode, letters and phonics can be uncovered one by one, offering guidance in the decoding process. After practicing decoding methods as described herein, a person can then transfer their new ability to decode to other reading texts independently.

In a preferred embodiment learning system 100 does not divide reading concepts and skills into separate lessons selectable from a menu, but rather immediately presents a student with a very simple story, as shown below, and the student can learn each and every concept as necessary as the concepts appear in context during the task of actual reading. By learning concepts during the real-life context of the actual task, the activity can be meaningful, and the student can understand the relevance of each concept and how to apply the information when it is actually necessary. By comparison, when skills are taught in isolation via separate lessons, concepts and information can be separated from the actual task of reading. Thus, although a person may diligently complete all their exercises, such person may not understand the relevance of these isolated lessons to the actual task of reading, where skills must often be combined. Thus, the information and skills can appear random to a student and the student may fail to effectively apply the information to the actual reading context.

In one embodiment, learning system 100 can be an electronic device that teaches a beginner reader how to read and/or write. In such embodiment, learning system 100 can comprise a memory 101 and a processor 102. The memory can comprise a learning application 103 and a data 104. Processor 102 can perform processes on data 104 according to learning application 103 stored in memory 101.

FIG. 1B illustrates a typical networking environment comprising a number of electronic devices 105 and a server 106, connected over a network 107. Examples of electronic devices 105 can include, but are not limited to, a computer 105a, a smart phone 105b, and/or a tablet 105c. In one embodiment, electronic devices 105, and server 106 can communicate with each other. Network 107 can be a wide-area network (WAN), local-area network (LAN), piconet, or any combination thereof. Network 107 can be hard-wired, wireless, or a combination of both. An example of a LAN is a network within a single building. An example of a WAN is the Internet.

FIG. 1C illustrates an electronic device 105 comprising a local memory 101a and a local processor 102a. Local memory 101a can comprise a local application 103a and local data 104a.

FIG. 1D illustrates a server 106 comprising a server memory 101b and a server processor 102b. Server memory 101b can comprise a server application 103b and server data 104b.

In one embodiment, learning application 103 can mean local application 103a wherein interface, presentation, logic, and data storage are controlled locally on electronic device 103a. In such embodiment memory 101 can mean local memory 101a, processor 102 can mean local processor 102a, and data 104 can mean local data 104ab.

In another embodiment, learning application 103 can mean local application 103a together with server application 103b. One example of such embodiment is where local application 103a is a general-purpose (browser) application. Another example of such embodiment is where local application is a specific-purpose (non-browser) application.

In the first example, a browser accesses server application 103b via a website. In such embodiment, interfacing with the student would occur on electronic device, presentation can be performed by local application 103a and server application 103b, while logic and data storage can be performed by server 106. In such example, memory 101 could mean electronic device memory 101a and/or server memory 101b, processor 102 would mean electronic device processor 102aand/or server processor 102b, and data 104 would mean server data 104b.

In the second example, the specific-purpose application accesses server application 103b. In such embodiment, interfacing with the student would occur on electron device 105, while presentation, logic, and data storage can be distributed between both electronic device 105 and server 106. In such example, memory 101 would mean electronic device memory 101a and/or server memory 101b, processor 102 could mean electronic device processor 102aand/or server processor 102b, and data 104 would mean local data 104a and/or server data 104b.

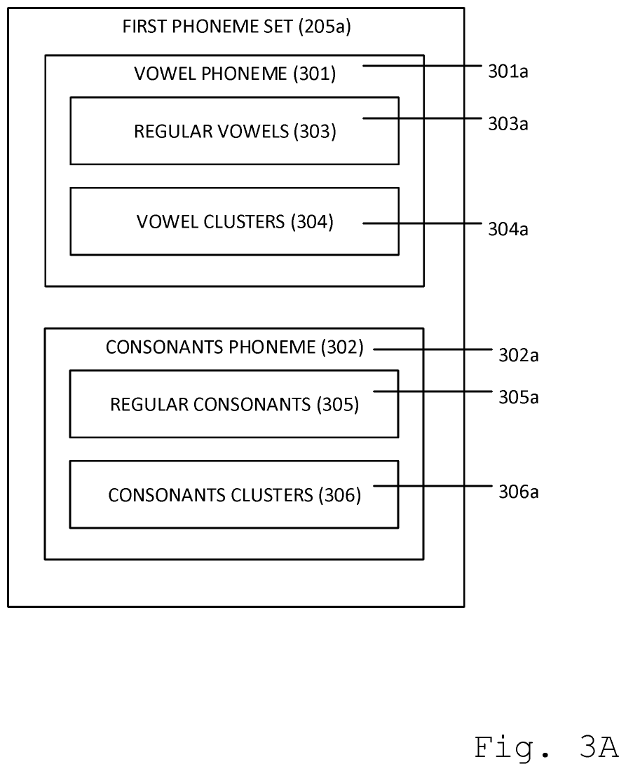

FIG. 2 illustrates a data store 104 comprising a user account 201 and one or more stories 202, and one or more phoneme sets 205. In one embodiment, there can be a plurality of phoneme sets 205, each phoneme set 205 varying in information and difficulty. In such embodiment, each phoneme set 205 can be introduced at varying times during a learning method so that the student can learn basic skills and then steadily build on those skills new phoneme sets 205 are introduced. As an exemplary embodiment, data store 104 can comprise a first phoneme set 205a, a second phoneme set 205b, and a third phoneme set 205c.

In one embodiment, user account 201 can comprise unique user information 201a that can include but is not limited to, name, age, email address, username, and/or password. User account 201 can be created using any methods known in the art including but not limited to direct web registration or via a representative. In one embodiment, user account 201 can further comprise a reading level 201b of the student. In one embodiment, learning application 103 can pre-select reading level 201b to be applied for each user account 201 according to user information stored in user account 201, which can be further discussed below. In another embodiment, the student can set reading level 201b initially. Further, learning system can adjust reading level 201b based on the student's progression and/or performance using learning system 100. User account 201 can also comprise a vowel priming method setting 201c that allows the student to choose between a two-step vowel-priming method, a three-step vowel-priming method, or a combination of the two. In another embodiment, learning system can vary vowel priming method setting 201c depending on reading level 201b of the student.

Each story 202 can be a narrative comprising a plurality of words 203. Each word 203 can be selectively chosen to cover one or more concepts needed to teach a person how to read. In one embodiment, stories 202 can comprise stories for various reading levels 201b, as discussed below. Phoneme 204 is a unit of sound used to distinguish one word from another in a language while letters 207 are characters used to depict the sounds in writing. In written language, phoneme 204 can be represented by one or more grapheme 206, each grapheme 206 comprising one or more letters 207 in a particular pattern. Each phoneme 204 can be associated with a graphic having a relationship with such phoneme. For example, for the phoneme 204 “/\check{a}/”, an image of a cat can be associated with such phoneme 204. A grapheme is the smallest functional unit of a writing system. Examples of a grapheme include each of the twenty-six letters 207 of the English alphabet. Grapheme 206 can be a combination of letters 207, symbols, and characters. In an example, grapheme can be tonal markers such as “\check{a}”, “æ”, “ā”, etc. For purposes of teaching reading and writing by learning system, phonemes 204 can be assigned to one or more phoneme sets 205, and each phoneme set 205 can be introduced to the student in accordance with methods described herein can be introduced to the student to teach the student to read phoneme set 205 can comprise phonemes 204 of a language that can be used in decoding words 203 within each story 202. Each word 203 can comprise one or more phonemes 204. Further, each phoneme set 205 can vary in phonemes 204 by difficulty. Further, each grapheme 206 of a set of graphemes 206 can represent phoneme 204, each phoneme 204 can be associated with the set of graphemes together make a set of phonemes 204. The set of phonemes 204 together audibly can construct word 203.

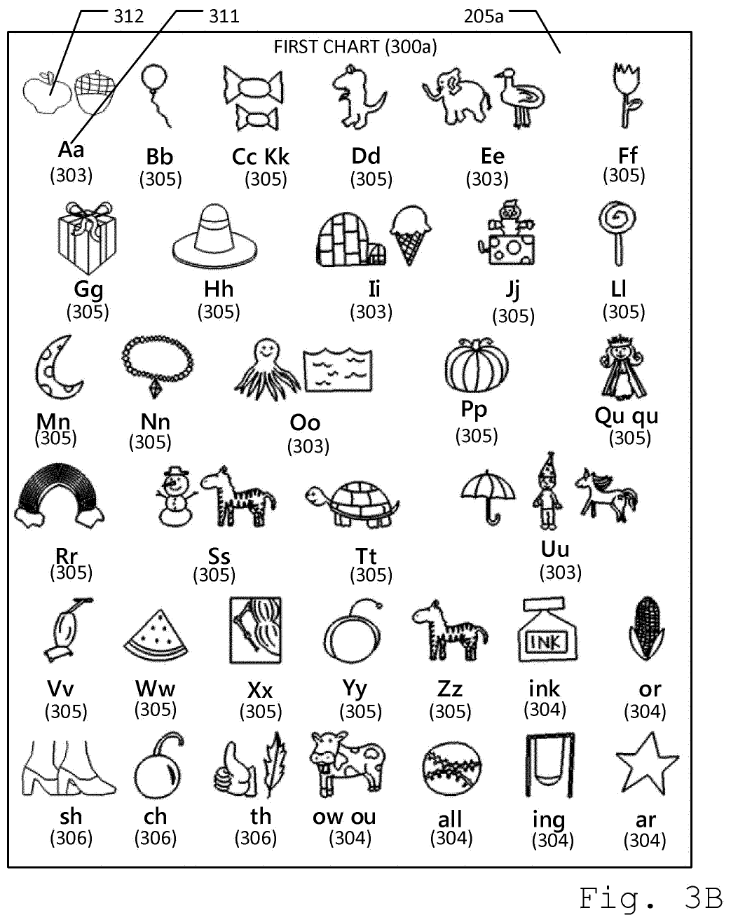

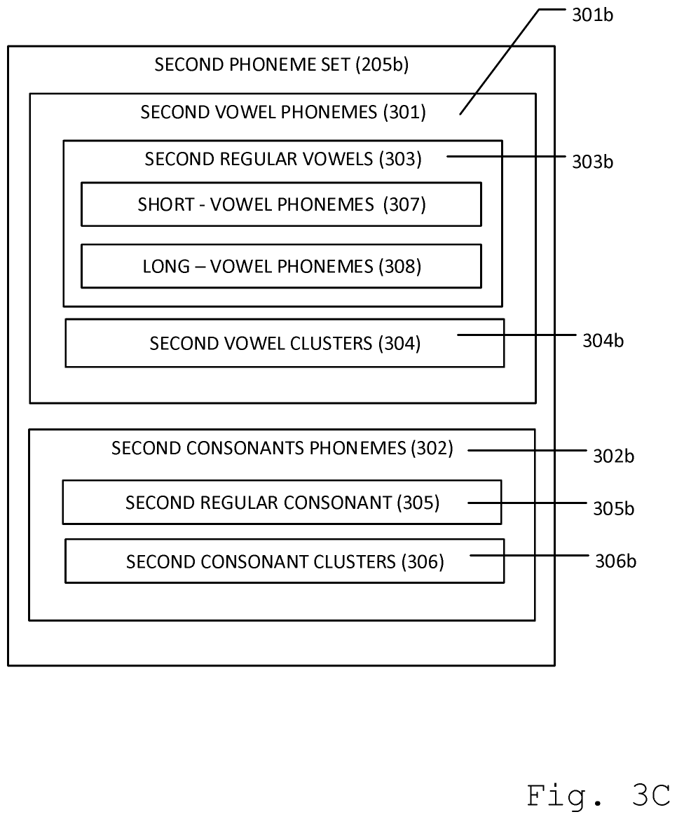

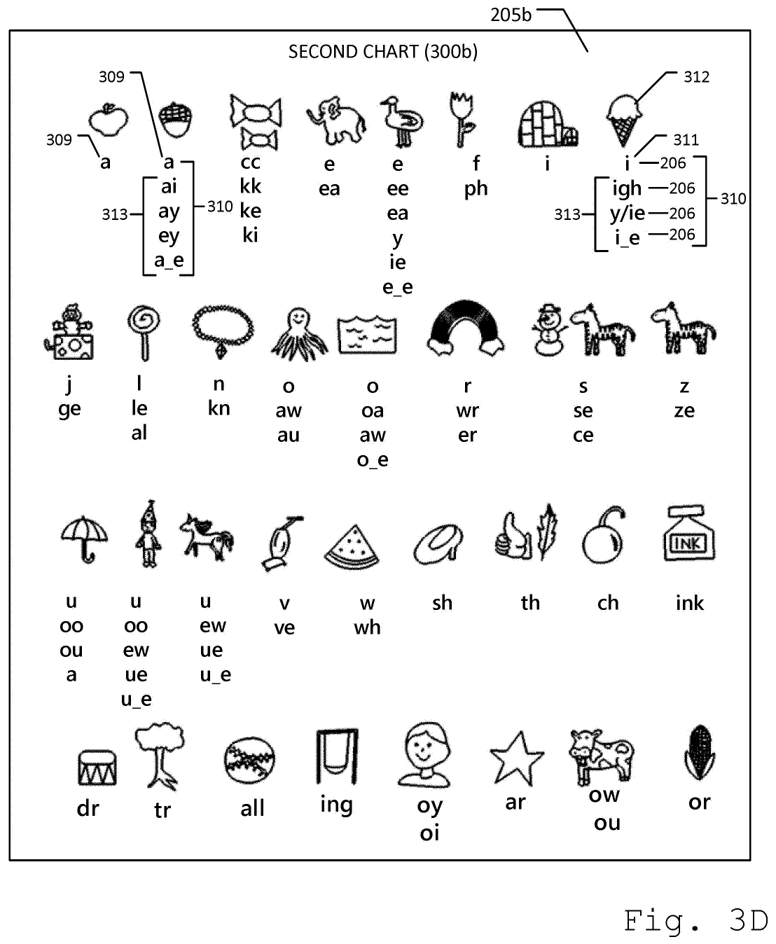

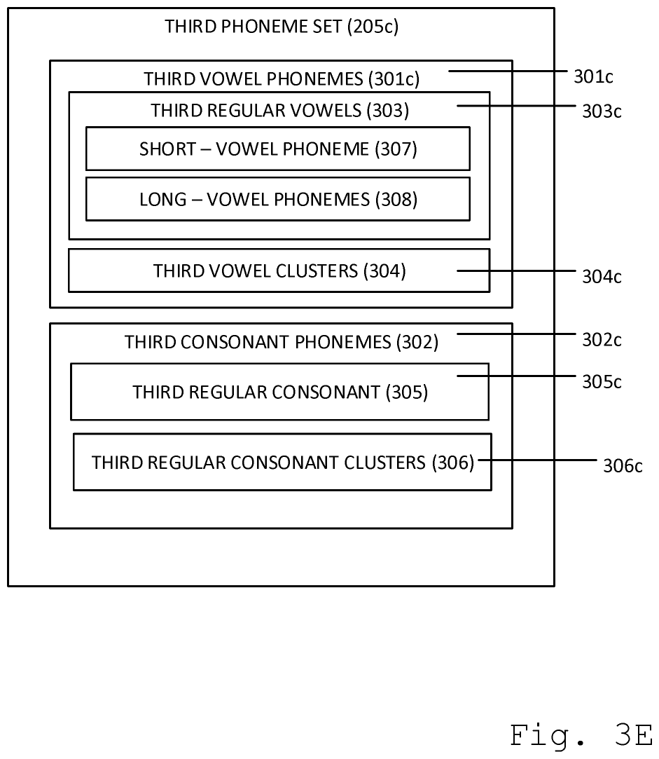

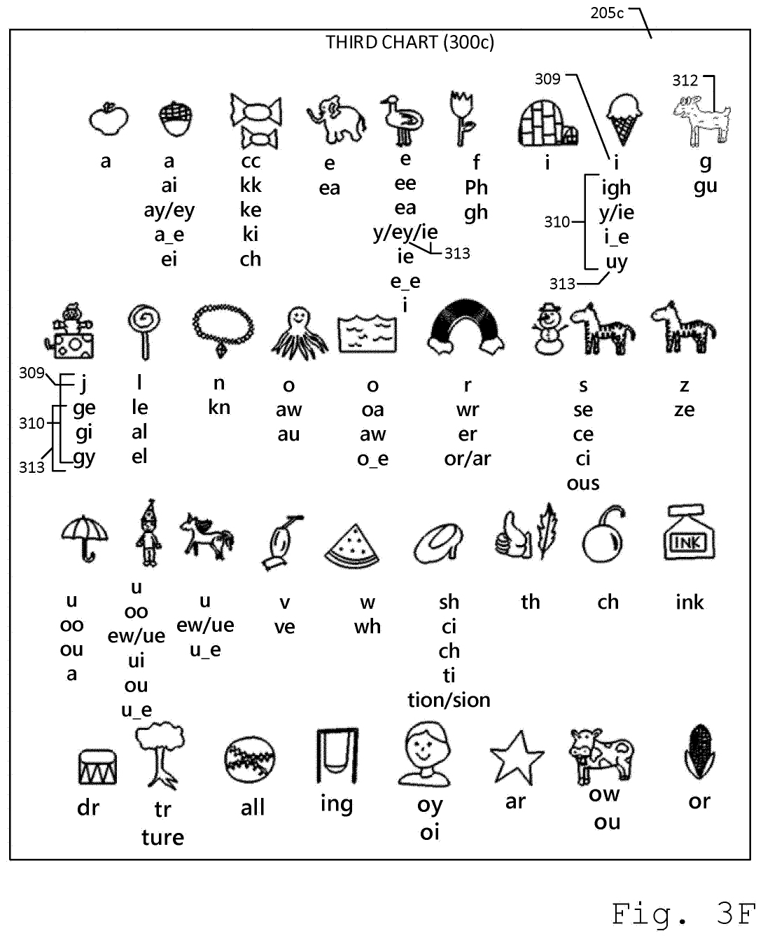

FIG. 3A illustrates an exemplary data model of first phoneme set 205a of phonemes 204. First phoneme set 205a can be used to introduce reading to a beginner reader. In one embodiment, first phoneme set 205a can comprise phonemes 204 that are most common in a language and/or having phonemes 204 each represented by one or more of the simplest and/or most common graphemes 206 (such as grapheme 206 comprising only one letter 207). For example, in one embodiment, first phoneme set 205a can comprise the most common phoneme 204 represented by each individual letter 207 in the English alphabet. Each phoneme 204 can further be categorized as a vowel phoneme 301 or a consonant phoneme 302. In this embodiment, first vowel phonemes 301a can be represented by one or more regular vowels 303, and/or one or more vowel clusters 304. Further, in one embodiment, first consonant phonemes 302acan comprise one or more regular consonants 305 and/or one or more consonant clusters 306. For purposes of this disclosure, regular vowel 303 is grapheme 206 that represents a vowel phoneme and comprises only one letter 207, and vowel cluster 304 is grapheme 206 that represents a vowel phoneme and comprises more than one letter 207. Similar, regular consonant 305 is grapheme 206 that represents a consonant phoneme and comprises only one letter 207, while consonant cluster 306 is grapheme 206 that represents a consonant phoneme and comprises more than one letter 207. First phoneme set 205a can comprise one or more first vowel phonemes 301a, and a one or more first consonant phonemes 302a. First vowel phonemes 301a can comprise first regular vowels 303a and/or first vowel clusters 304a. First consonant phonemes 302acan comprise first regular consonants 305a and first consonant clusters 306a.

FIG. 3B illustrates a first chart 300a of charts 300 illustrating first phoneme set 205a. In this embodiment, first phoneme set 205a can comprise regular vowels 303, vowel clusters 304, regular consonants 305, and consonant clusters 306. In English, regular vowels 303 can comprise of vowels “a”, “e”, “i”, “o”, and “u”, while vowel clusters 304 can comprise of vowel clusters “ee”, “oo”, “ow/ou”, and for purposes of this disclosure is expanded to include common vowel-consonant arrangements such as “ink”, “all”, and “ing”, “or”, and “ar”. Examples of regular consonants 305 include, but are not limited to, “b”, “c”, “and “d.”, while examples of consonant clusters 306 can include, but are not limited to “sh”, “ch”, and “th.”

While a person of ordinary skill in the art would recognize that certain nomenclature has been developed to refer to specific phonemes 204 such as “/\check{a}/”, each phoneme 204 within chart 300 can be represented within learning system 100 using a representative grapheme 311 and/or a representative image 312. Representative image 312 can relate to word 203 that comprises phoneme 204. Depending on context, representative image 312 can be used to communicate to a student either word 203 or phoneme 204. In another embodiment, learning application 103 can represent phoneme 204 using nomenclature known in the art. For purposes of this disclosure, a grapheme 206 when not a representative grapheme 311 can be referred to as a secondary grapheme. In one embodiment, graphemes 206 introduced within first phoneme set 205a can consist of representative graphemes 311.

FIG. 3C illustrates an exemplary data model of second phoneme set 205b of phonemes 204. In many languages such as English, the relationship between phonemes 204 and graphemes 206 is not 1:1. One grapheme 206 represent more than one phoneme 204, and phoneme 204 can be represented by more than one grapheme 206.

In English, regular vowels 303 not only represent a short-vowel phoneme 307, but also one or more long-vowel phonemes 308. For example, the short-vowel phoneme 307 “/\check{a}/” as in “apple” and long-vowel phoneme 308 “/\check{a}/” as in “acorn” are each represented by the regular vowel “a”. Similarly, regular vowel 303 “u” not only one short-vowel phoneme 307 “/\check{u}/”, which can have an “uh” sound such as in the word “umbrella”, but it also represents two long-vowel phonemes 308 of “/\check{u}/”, “oo” (as in flu or frugal), or “yoo” (as in “mutant” or “music”). Vowel clusters 304 can represent more than one vowel phoneme 301 as well. For example, vowel cluster 304 “ei” can represent long-vowel phonemes 308 “/ā/”, “/ē/” and “/1̅/” (see, e.g., “reindeer”, “receive”, and “Einstein”). Further, just as one grapheme 206 can represent more than one phoneme 204, phoneme 204 can be represented by more than one grapheme 206. For example, vowel phoneme 301 /ē/ can be represented by multiple graphemes 206 including “ee”, “ea”, “e_e”, and “y” (see, e.g., “meet”, “meat,” “here,” and “very”).

Both are true for consonants as well. For example, regular consonant 305 c can represent both phoneme 204 “/c/” as in “cold,” or “Is!” as in ceiling. Going the other way, phoneme 204 “/c/” can be represented using graphemes 206 “c”, “k”, or “ck” (see, eg., “cold”, “kite”, and “rock”).

A purpose of second phoneme set 205b is to begin or continue introducing such complexities of a language to the student. To that end, second phoneme set 205b can comprise a second set of phonemes 204. Similar to first phoneme set 205a, second phoneme set 205b can comprise one or more second vowel phonemes 301b, and a one or more second consonant phonemes 302b. Second vowel phonemes 301b can comprise second regular vowels 303b and/or second vowel clusters 304b. Second consonant phonemes 302b can comprise second regular consonants 305b and second consonant clusters 306b. In one embodiment, second phoneme set 205b can comprise a set of phonemes 204 with different or additional phonemes 204 as compared to first phoneme set 205a. In one embodiment, the different or additional phonemes 204 can comprise phonemes 204 less common and/or more complex than first phoneme set 205a. In another embodiment, second phoneme set 205b can comprise some or all of the same phonemes 204 as first phoneme set 205a, but with different or additional graphemes 206. Such different or additional graphemes 206 can increase in difficulty or obscurity compared to graphemes 206 in first phoneme set 205a. As the student masters first phoneme set 205a, learning system 100 can begin to introduce words 203 with graphemes 206 from second phoneme set 205b as part of its methodology in teaching the student to read. Further, within learning system 100, graphemes 206 can each be associated in data store 104 with each phoneme 204 that grapheme 206 can represent.

FIG. 3D illustrates a second chart 300b of second phoneme set 205b illustrating phonemes 204 having more than one grapheme 206, arranged together on second chart 300b with those graphemes 206. For purposes of this disclosure, phoneme 204 represented by more than one grapheme 206 are referred to as a homophone 309. Graphemes 206 related to a common homophone 309 are collectively referred to as a grapheme family 310. In one embodiment, graphemes 206 different or additional graphemes 206 introduced within second phoneme set 205b can comprise of all or a portion of secondary graphemes 313 for each grapheme family 310 of a set of grapheme families 310. Such set of grapheme families 310 can consist of all or a portion of grapheme families within a language. Each grapheme family 310 can comprise one or more grapheme family member 310b. In an example illustrated in FIG. 3F, grapheme family 310 for phoneme 204 “j” for third chart 300c can comprise graphemes 206 “j”, “ge”, “gi”, and “gy”. In such example, grapheme family member 310b of phoneme 204 “j” can comprise “ge”, “gi”, and “gy”. Further, each of grapheme 206 can be associated with one or more of the plurality of charts 300.

FIG. 3E illustrates an exemplary data model of third phoneme set 205c of phonemes 204. A purpose of third phoneme set 205c is to continue introducing new complexities of a language to the student. To that end, third phoneme set 205c can comprise a third set of phonemes 204. Similar to second phoneme set 205b, third phoneme set 205c can comprise one or more third vowel phonemes 301c, and a one or more third consonant phonemes 302c. Third vowel phonemes 301c can comprise third regular vowels 303c and/or third vowel clusters 304c. Third consonant phonemes 302c can comprise third regular consonants 305c and third consonant clusters 306c. In one embodiment, third phoneme set 205c can comprise a set of phonemes 204 with different or additional phonemes 204 as compared to first phoneme set 205a and second phoneme set 205b. In one embodiment, the different or additional phonemes 204 can comprise phonemes 204 less common and/or more complex than second phoneme set 205b. In another embodiment, third phoneme set 205c can comprise some or all of the same phonemes 204 as first phoneme set 205a and second phoneme set 205b, but with different or additional graphemes 206. Such different or additional graphemes 206 can increase in difficulty or obscurity compared to graphemes 206 in first phoneme set 205a and second phoneme set 205b. As the student masters first phoneme set 205a and second phoneme set 205b, learning system 100 can begin to introduce words 203 with graphemes 206 from third phoneme set 205c as part of its methodology in teaching the student to read.

FIG. 3F illustrates a third chart 300c of third phoneme set 205C illustrating phonemes 204 having more than one grapheme 206, arranged together on third chart 300c with those graphemes 206. In one embodiment, graphemes 206 different or additional graphemes 206 introduced within third phoneme set 205c can comprise additional secondary graphemes 313 for each grapheme family 310 of a set of grapheme families 310, not previously introduced in either first phoneme set 205a or second phoneme set 205b. Such set of grapheme families 310 can consist of all or a portion of grapheme families within a language.

FIG. 3G illustrate charted grapheme-phoneme pairs 316 for one charted phoneme 314 within a set of charted grapheme-phoneme pairs 317. For purposes of this disclosure, set of charted grapheme-phoneme pairs 317 comprises all grapheme-phoneme pairs for all charted phonemes 316 represented on charts 300. Each charted grapheme phoneme pair 316 can comprise one charted phoneme 314 associated with one charted grapheme 315. The relationship between charted phoneme 314 and charted grapheme 315 within grapheme-phoneme pair 316 is such that charted grapheme 315 is an acceptable graphic encoding of charted phoneme 314, and phoneme 314 is an accepted audible decoding of grapheme 315.

In one embodiment, each phoneme 204 can match charted phonemes of a set of charted phonemes 314. Each chart 300 can represent phonemes 314 each associated with graphemes 315 of a set of charted graphemes 315. In such embodiment, the student can be provided one or more charts 300, each communicating sets of charted grapheme-phoneme pairs 317. As an example, set of charted grapheme-phoneme pairs 317 can comprise charted phonemes 314 “/ā/” making pairs with each grapheme 315 associated with charted phoneme 314 “/ā/”, as illustrated in FIG. 3G.

As an example, embodied in first chart 300a can be a first subset of charted phonemes 318a and for each charted phoneme 314 of first subset of charted phonemes 318a a first subset of charted graphemes 319a of one or more sets of charted graphemes 315. Each charted grapheme 315 within a first subset of charted graphemes 319a together with associated charted phoneme 314 is a first chart grapheme-phoneme pair 320a of the set of charted grapheme-phoneme pairs 317.

As another example, embodied in second chart 300b can be a second subset of charted phonemes 318b and for each charted phoneme 314 of second subset of charted phonemes 318b a second subset of charted graphemes 319b of one or more sets of charted graphemes 315. Each charted grapheme 315 within the second subset of charted graphemes 319b together with associated charted phoneme 314 a second chart grapheme-phoneme pair 320b of the set of charted grapheme-phoneme pairs 317.

In this embodiment wherein embodied in the first chart 300a of the one or more charts 300 are a first subset of charted phonemes 318a and for each the charted phoneme 314 of the first subset of charted phonemes 318a first set of charted graphemes 315 of the one or more sets of charted graphemes 315. Each of the charted grapheme 315 within the first subset of charted graphemes 319a together with the charted phoneme 314 a first chart grapheme-phoneme pair 320a of the set of charted grapheme-phoneme pairs 317.

Further, each chart 300 can be fixed in tangible form that is readable by the student. An example of chart 300 fixed in tangible form can be a chart 300 written or printed on paper wherein the student can read the set of charted graphemes 315. Examples of paper can include a sheet of paper, cardboard, a sticker or any other paper known in the art.

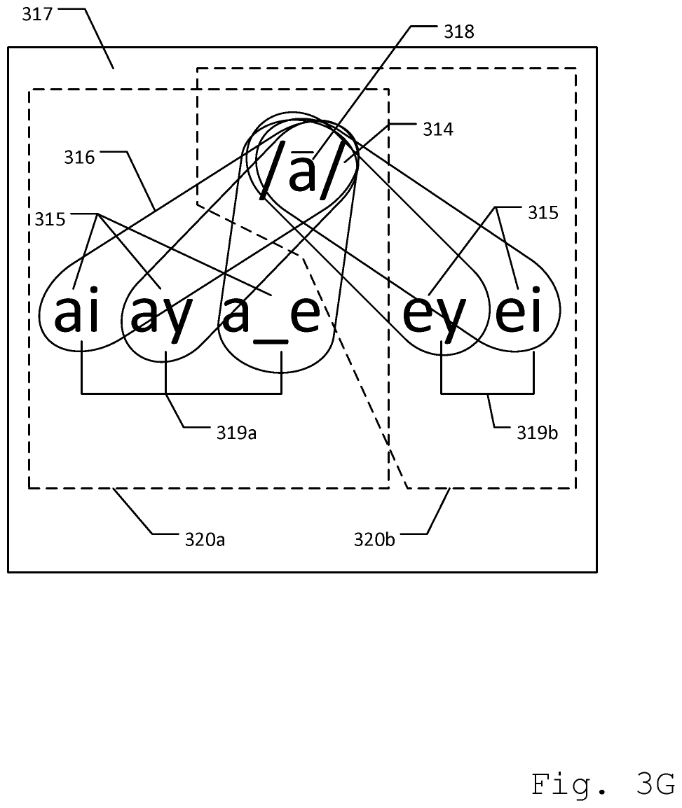

FIG. 4 illustrates a reading routine 401. Reading routine 401 can be used to teach the student how to read. In one embodiment, an instructor such as a parent or teacher can perform reading routine 401 with the student learning to read. In another embodiment, learning application 103 can perform reading routine 401.

Similarly, a writing routine 402 can be used to teach the student how to write. In one embodiment, a person such as a parent or teacher can perform writing routine 402 with the student learning to write. In another embodiment, learning application 103 can perform writing routine 402, as discussed further below.

The instructor or learning application 103 can track the student's progress and allow the student to progress through reading routine 401 and/or writing routine 402 in one more sessions, each session the student completing a portion of reading routine 401. In a scenario wherein the student previously accessed learning application 103, learning application 103 can enter reading routine 401 at or near where the student left off. Within learning application 103, the student can use a graphical user interface to navigate to and interact with reading routine 401 and writing routine 402.

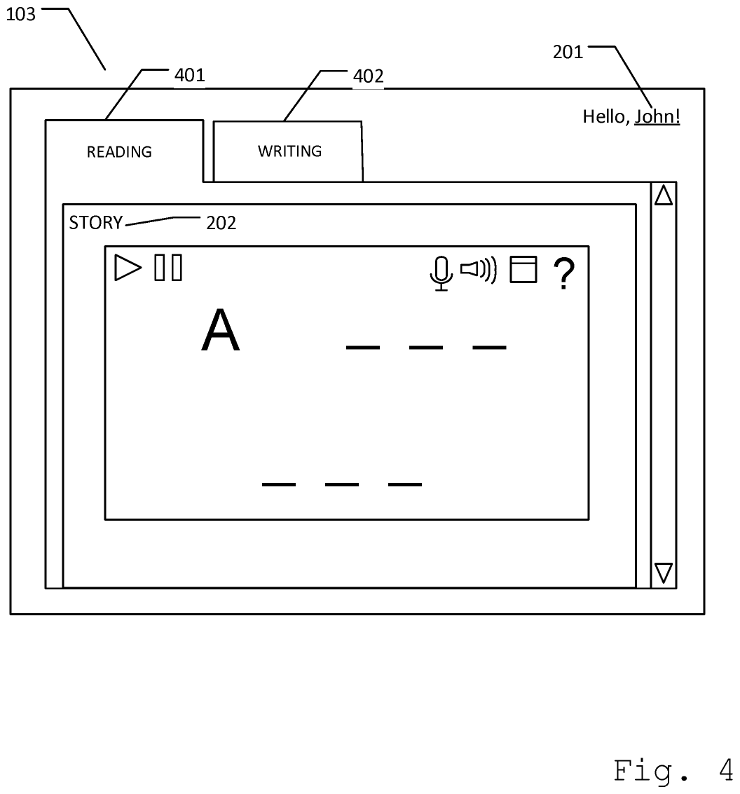

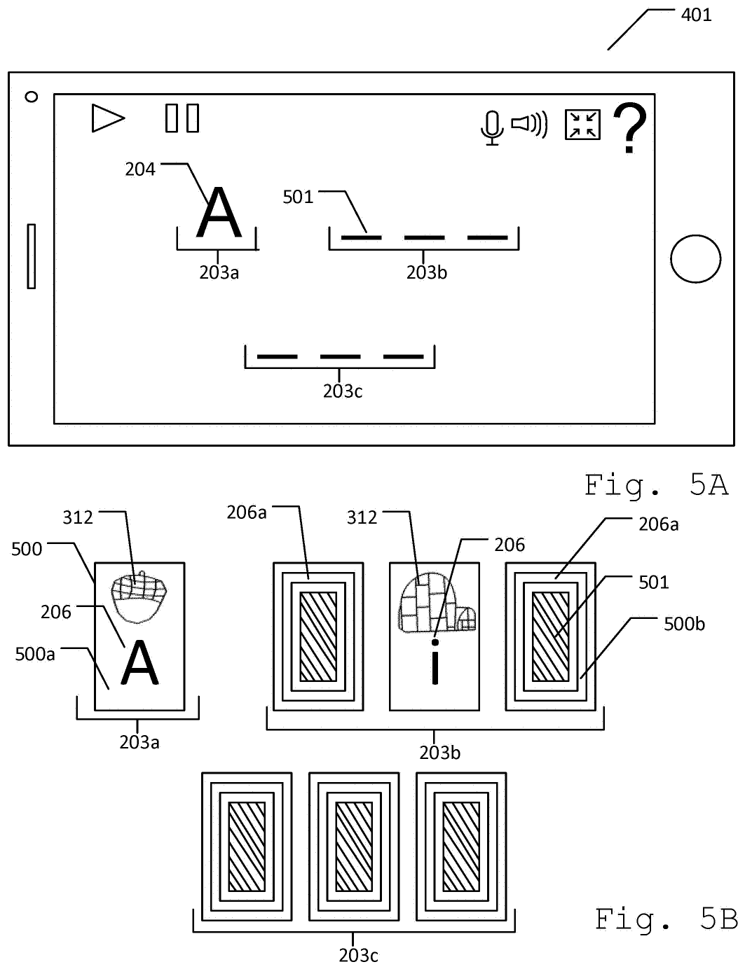

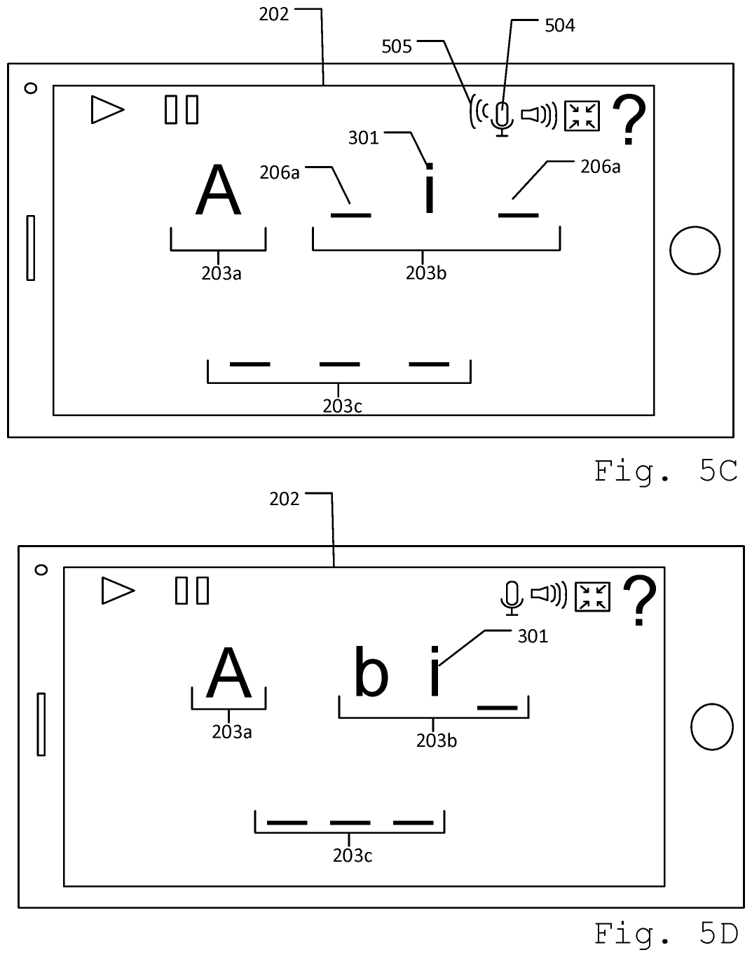

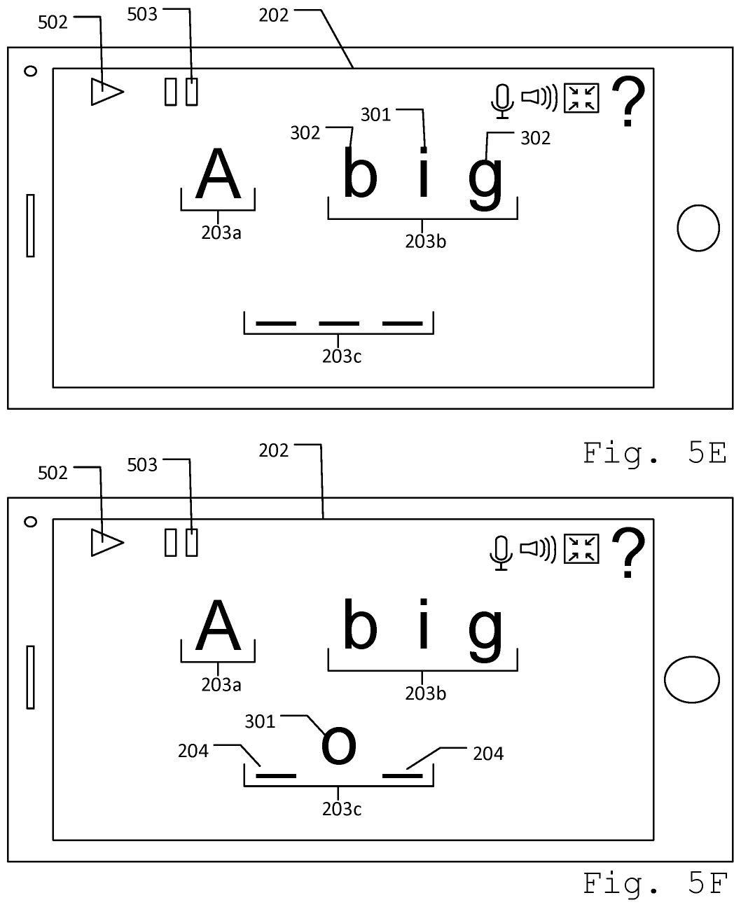

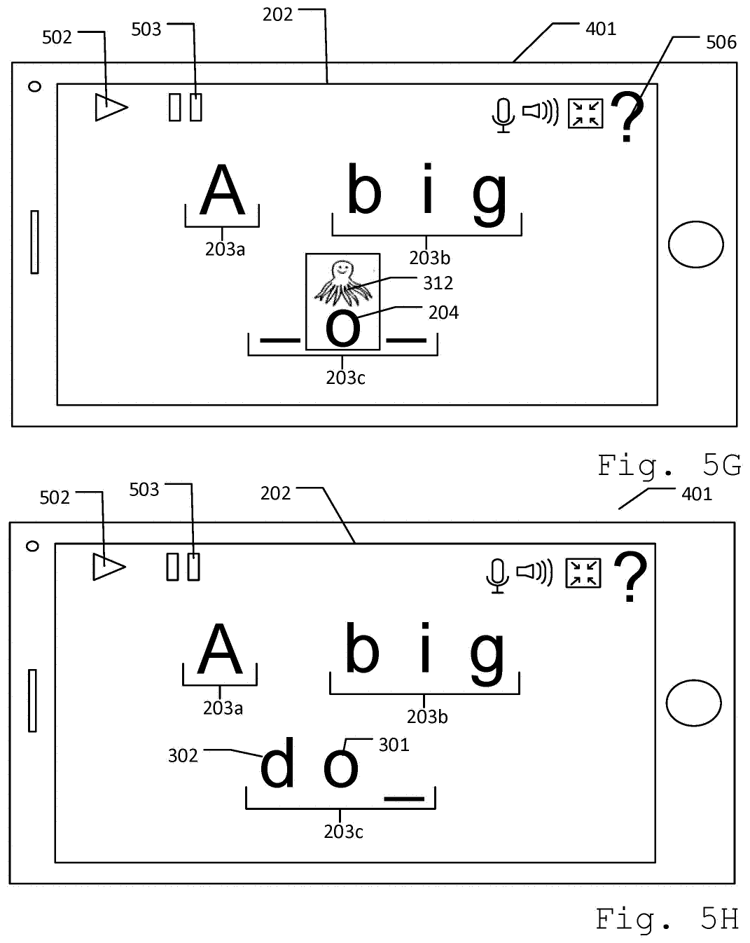

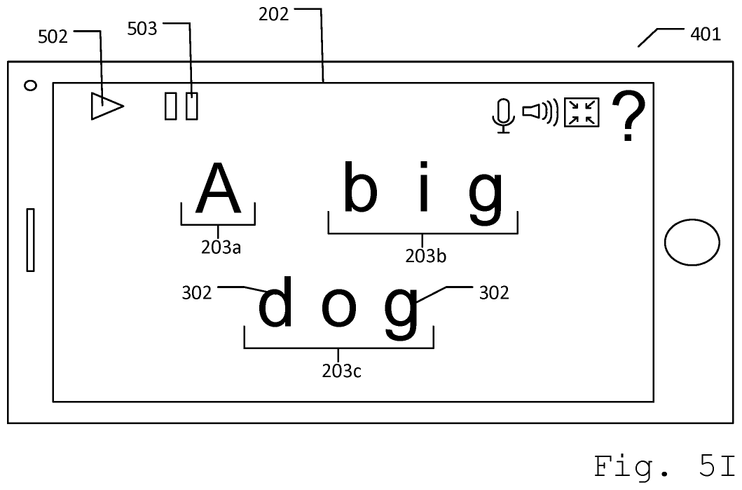

FIGS. 5A-5I together illustrate a three-step vowel priming method within reading routine 401 using graphemes 206 from first chart 300.

FIG. 5A illustrates decoding word 203a consisting of one phoneme 204, within a three-step vowel priming method of reading routine 401. For purposes of this disclosure, story 202 is a collection of words 203 organized into a phrase, sentence, or collection of phrases and/or sentences related in content. Furthermore, each word 203 in story 202 can comprise one or more phonetic words or one or more non-phonetic words. In this disclosure, if a spoken word of word 203 comprises a set of phonemes 204 in an order such that when the set of phonemes is spoken, set of phonemes 204 form the spoken word, each word 203 can be a phonetic word if all grapheme-phoneme pairs 316 between the spoken word of word 203 and a conventional spelling of word 203 match at least one charted grapheme-phoneme pair 316 within set of charted grapheme-phoneme pairs 317, and a non-phonetic word if not.

In this case, first word 203a “A” is a phonetic word since phoneme 204 of first word 203a matches one or more set of charted phonemes 314. Moreover, grapheme 206 of first word 203a “A” matches one or more of the charted graphemes 315. Furthermore, phonetic words can be presented to the student according to vowel priming method as discussed below, while non-phonetic words can be presented to the student contemporaneously or by displaying all letters 207 at once. Some examples of non-phonetic words can include but is not limited to, “two”, “want”, “comb”, and “breakfast”.

Initially, one or more, and possibly a set of graphemes 206 of each word 203 can each be hidden individually. The set of graphemes 206 can be arranged such that when completely unhidden together can graphically construct word 203. For purposes of this disclosure, hidden can mean covered, obscured, replaced with a generic symbol 501 such as an underscore, or simply not displayed. Other examples of generic symbol 501 can comprise an asterisk, block, or box.

FIG. 5B illustrates using cards 500 to perform methods as described herein. Further generic symbol 501 can be a generic backing to a set of cards, each card 500 of a set of cards 500 having a face 500a displaying grapheme 206, and a back 500b comprising generic symbol 501 common to all the cards. In one embodiment, face 500a can further comprise representative image 312. Representative image 312 can be associated with phoneme 204 of grapheme 206. In such embodiment, hiding grapheme 206 can comprise placing the card face down. Displaying grapheme 206 can comprise, for example, starting a face up or flipping it from face down to face up. Revealing grapheme 206 can comprise the step of turning the card from face down to face up. While back 500b can comprise generic symbol 501, other features of back 500b can have attributes such as a color or sequential marking that communicate to a teacher or student an order in which cards 500 should be laid out, an order in which the cards should be turned over, and/or where each word 203 begins and ends. For example, backs 500b of cards 500 belonging to one word 203 may all be blue, while backs 500b of cards 500 belonging to a next word 203 may be green. Additionally, backs cards 500b of a common word 203 or story 202 may have some sort of sequential marking, e.g., 1, 2, 3, or A, B, C, that communicate an order in which cards 500 should be tuned over. In one embodiment, two or more cards 500 may have a common sequential marking to indicate such cards should be turned over together. In yet another embodiment, back 500b can be marked to indicate it should be stacked with another card 500b, such stacking for use in a writing method as discussed below wherein a student replaces one grapheme 206 with another. In such embodiment, the student could turn over one card 500 on top, such card could then be taken away in a subsequent step, leaving a lower stacked card, and then the lower stacked card could be turned over in another subsequent step. In one embodiment, cards 500 can be laid out on a game board. In such embodiment, the game board can designate places each card 500 can be placed.

In accordance with reading routine 401, the student can be instructed to decode words 203 of a story in the order or occurrence. Further, the student can be instructed to, for each phonetic word 203, to decode each phoneme 204 or letter 207 as phoneme 204 or letter 207 is revealed. In FIG. 5A, story 202 starts with word 203 “A”, a single-phoneme word. As such, reading routine 401 displays “A” with representative image 312 of an “acorn”. This can help the student associate long-vowel phoneme 308 “a” with representative image of an “acorn”. In one embodiment, representative image 312 can only appear after the student decodes each phoneme 204. For purposes of this disclosure, to display within this context can either mean to reveal that which was previously hidden, or to simply show without it being previously hidden. Then reading can comprise the step of pausing and giving student time to pronounce vowel phoneme 301 displayed.

Further in this example embodiment wherein word 203 is a phonetic word, cards 500 that represent a set of graphemes 206 of word 203b can be initially hidden, by placing the three cards faced down. Next, the instructor can first reveal vowel phoneme 301 by turning the middle card face up revealing middle vowel grapheme 206 “i” while leaving remaining graphemes 206a hidden by leaving the cards comprising remaining graphemes 206a “b” and “g” face down. Furthermore, displaying each vowel grapheme and remaining graphemes. Further in an embodiment wherein word 203 is a non-phonetic word, a subset of cards 500 that represent each letter of the non-phonetic word can be presented to the student face-up. In such embodiment, each face 500a of the subset of cards can comprise each letter that together can construct the non-phonetic word. In another embodiment, non-phonetic word 203 can be presented to the student, face-up. As such, face 500a can comprise non-phonetic word.

FIG. 5C illustrates revealing middle-vowel grapheme 206 in a three-step vowel priming method. In a vowel-priming method, vowel graphemes 206 of a set of graphemes can first be displayed to the student, while remaining graphemes 206a of the set of graphemes can be hidden. In this method, remaining graphemes 206a can each be represented by generic symbol 501. The set of graphemes can be arranged such that when completely unhidden together can graphically construct word 203. As an example, the student can be introduced to middle-vowel grapheme 206 in the middle of word 203 before being introduced to consonant graphemes 206 at the beginning of word 203. For example, reading routine 401 teaches reading word 203b, comprising three phonemes 204, using a three-step vowel priming method. First, vowel grapheme 206 in the middle of word 203b is revealed, which in this example is an “i.” Next, the instructor or learning application 103 can pause to allow the student to determine phoneme 204 associated with vowel grapheme 206. For purposes of this disclosure, pausing can mean that the student is given a period of time to decode grapheme 206 and pronounce phoneme 204. In such scenario, the student can form the sound “i”. In one embodiment, learning system 100 when implemented in electronic device 105, can comprise a microphone 504 that can hear a student speak. In such embodiment, microphone 504 can receive a signal 505 representing a spoken sound from the student. Using audio processing techniques, learning application 103 can compare signal 505 to phoneme 204 and can determine whether the student has accurately decoded grapheme 206 of grapheme 206. In another embodiment, a teacher can determine whether the student has successfully decoded grapheme 206.

FIG. 5D illustrates revealing a remaining grapheme 206a at the beginning of a word, in a three-step vowel priming method. After displaying vowel grapheme 206, remaining grapheme 206a in one or more subsets of graphemes 206 can be revealed. For purposes of this disclosure, each subset can comprise one or more graphemes 206. As such, consonant grapheme 206 at the left side of middle-vowel grapheme 206 can be revealed, which in this example is a “b.” Then the student can be given another period of time to decode consonant grapheme 206. Decoding can include pronouncing consonant phoneme 302 and vowel phoneme 301 together. In such scenario, the student can combine the vowel sound “i” with consonant grapheme 206 “b” and can allow the student to form the sound “/ b \check{1}/”. Similar to above, electronic device 105 or a teacher can verify if the student is correct, in some embodiments.

FIG. 5E illustrates revealing a remaining grapheme 206a at the end of a word 203, in a three-step vowel priming method. The remaining graphemes can be revealed in order from a beginning of word 203 to an end of word 203. As such, after revealing grapheme 206 at the beginning of word 203b that is “b”, in a next step, consonant grapheme 206 to the right of middle-grapheme 206 can be revealed, which in this example is a “g.” Then, the student can be given another period of time to decode the ending grapheme 206 to produce consonant phoneme 302. Pausing after each revelation can allow the student to determine phonemes 204 associated with the subset of graphemes 206 revealed in the revelation. Such decoding can include pronouncing all three phonemes 204 together to read word 203b. As such the student can connect the sound “/ b \check{1}/” with the decoded consonant phoneme 302 “/g/” forming the sound “/b b \check{1}g/”. By this time, the student can completely read and decoded first word 203a “A” and second word 203b “big”.

In one embodiment, learning application 103 can automatically reveal each next by graphemes 206 of words 203 automatically without continued user instruction. For example, graphemes 206 could be revealed at a preset time interval, such as after every 10 seconds. Such time interval could be set by a student or instructor. In another embodiment, the student can communicate when the next grapheme 206 should be revealed, and the next grapheme can be revealed as a result of such communication. In one embodiment, the student can communicate by clicking on a continue button 502 and/or a stop button 503 that can allow the student to continue and/or stop learning application 103 from revealing each grapheme 206 of word 203 within story 202. In one embodiment, clicking continue button 502 can cause learning application 103 to reveal one and only one new grapheme 206, while maintaining other remaining graphemes 206a hidden.

FIG. 5F illustrates revealing middle-vowel grapheme 206 of another word 203c. In this example, word 203c also comprises a grapheme 206 preceding and following middle-vowel grapheme 206 “o”, the two consonants' graphemes 206 hidden.

FIG. 5G illustrates reading routine 401 capable of offering assistance. In an embodiment wherein the student needs assistance decoding the sound of grapheme 206 or wherein a grapheme 206 represents more than one phoneme 204, the student can click on help button 506, which can provide assistance to the student. In one embodiment, clicking help button 506 can teach the sound of the current letter or word being decoded, in this scenario an audio sound of letter “o” can be played. In another embodiment, clicking help button 506 can display representative image 312 associated with grapheme 206 and that is a part of the related word 203. As an example, representative image 312 displaying an “octopus” can be displayed while playing an audio sound that can pronounce short-vowel phoneme 307 “/o/” as in “octopus”. In a preferred embodiment, each phoneme 204 in story 202 can be displayed together with representative image 312 that is associated with grapheme 206. This can help the student to remember the sound of phoneme 204 associated with the representative image 312. As an example, when a student doesn't know the sound of grapheme 206 “o”, the instructor or learning application 103 can ask the student what is the picture for the grapheme 206 “o”. In such scenario, the student can recall representative image 312 “octopus” that is associated with the grapheme and can remember the sound of grapheme 206 “\check{0}”.

FIG. 5H illustrates revealing grapheme 206 at the beginning of another word 203c, in a three-step vowel priming method, similar as described above. Once the previously-concealed grapheme 206 “d” is revealed, the student can produce the sound of consonant phoneme 302 “g” and connect the sound to the first decoded sounds “/\check{o}/”. By combining the sounds together, the student can make the sound “/d \check{o}/”.

FIG. 51 illustrates revealing consonant grapheme at the end of word 203c, in a three-step vowel priming method, similar as described above. Once the previously-concealed grapheme 206 “g” is revealed, the student can produce the sound of consonant phoneme 302 “/g/” and connect the sound to the first decoded sounds “/d \check{o}/”. By combining the sounds together, the student can completely decode third word 203c “d\check{o}g/”. As such, the student has completely decoded the phrase “A big dog” by using the three-step vowel priming method. Reading routine can continue directing the student to read the rest of story 202, applying the same three-step vowel priming method as each word 203 can be revealed to the student, or by using a two-step vowel priming method, as further described below.

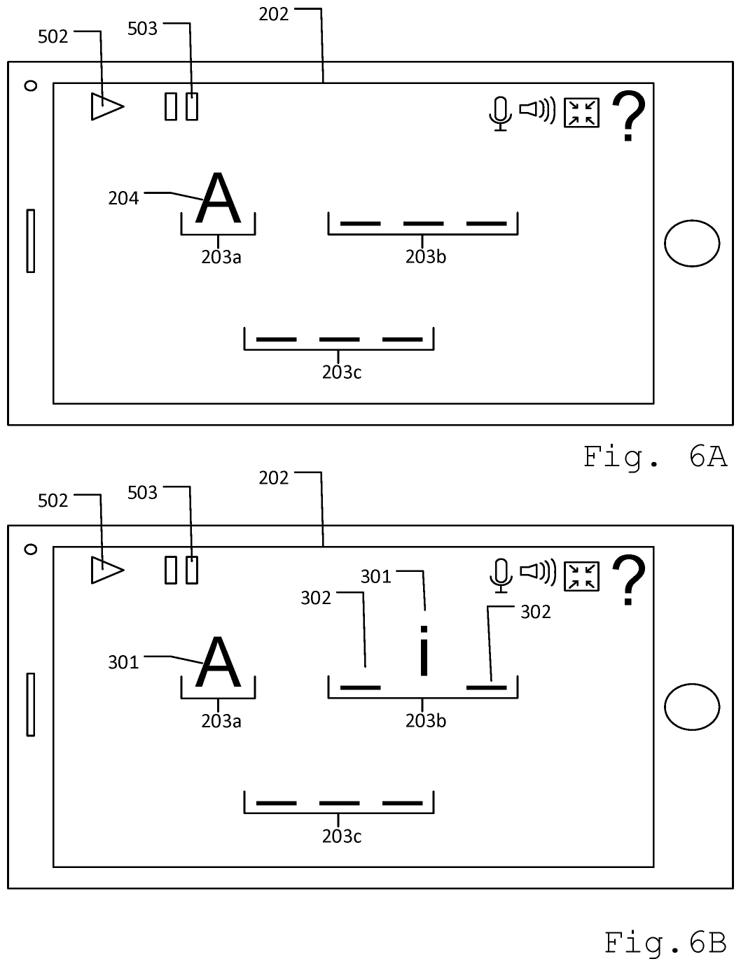

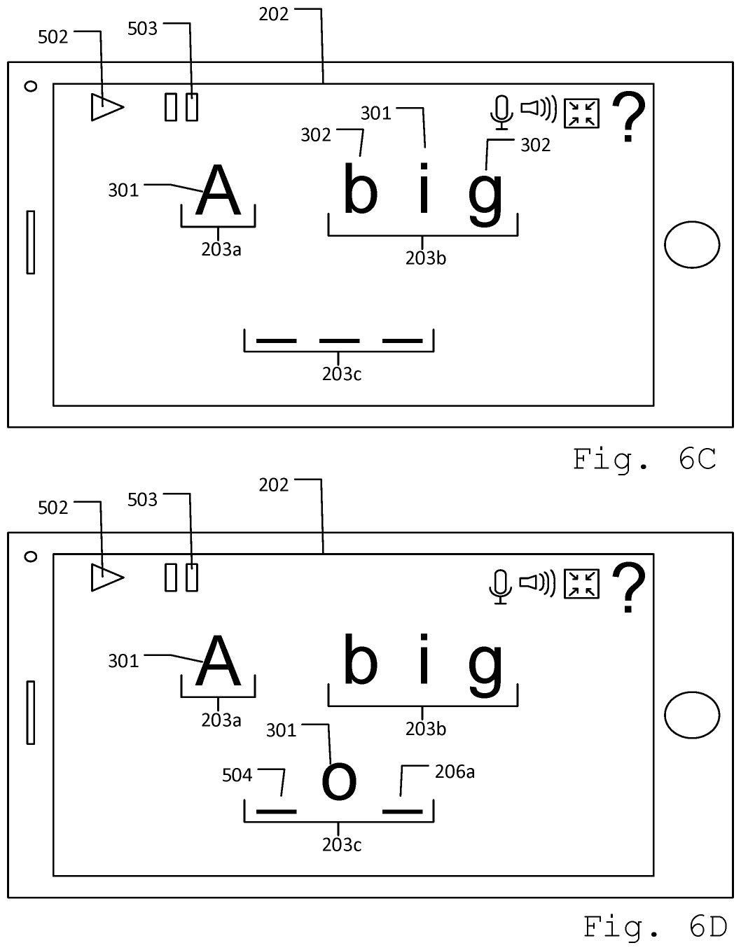

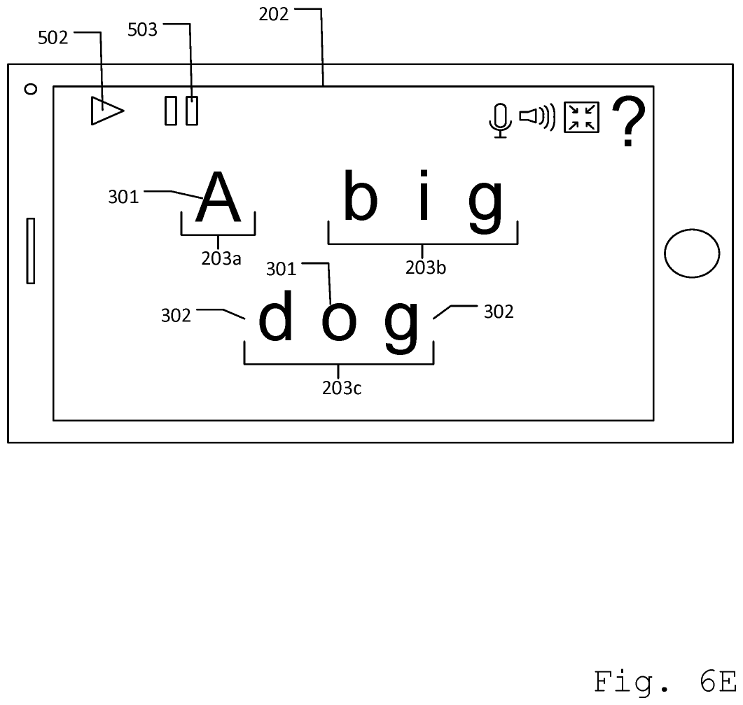

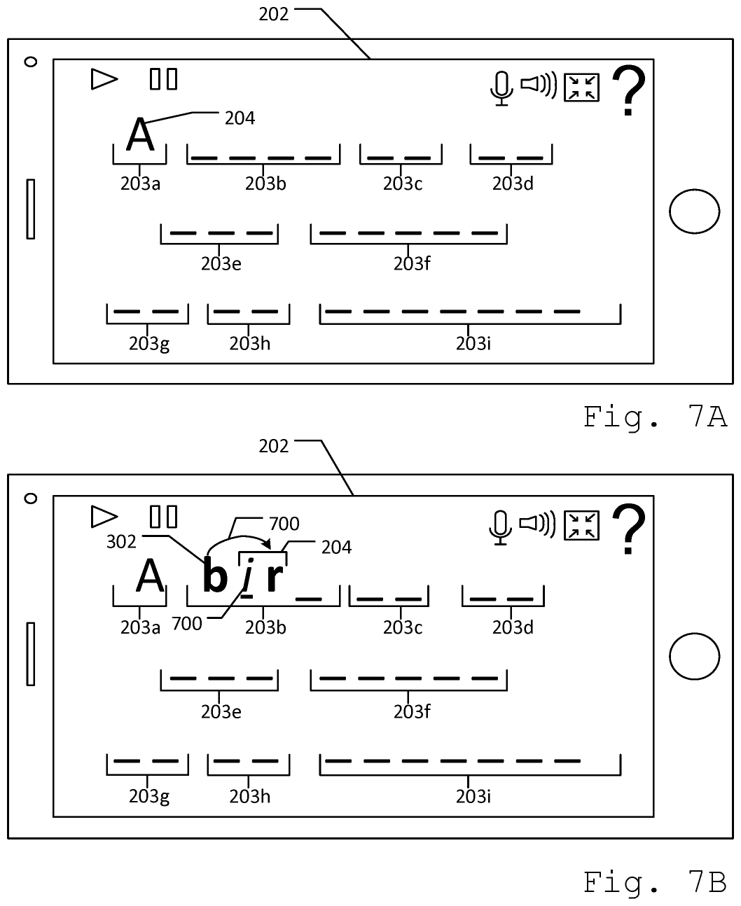

FIGS. 6A-6E together illustrate a two-step vowel priming method.

FIG. 6A illustrates decoding word 203a consisting of one phoneme 204, within a two-step vowel priming method of reading routine 401. For purposes of distinguishing between two-step vowel priming method and the three-step vowel priming method, the same story as above is used to illustrate the two-step vowel priming method. Initially, one or more, and potentially all graphemes 206 of each word 203 can each be hidden individually. Just as in the two-step vowel priming method, words 203 consisting of one phoneme 204 are decoded in the same way as in the three-step vowel priming method. Reading routine 401 would include displaying grapheme 206 “A”. Then, the student can then pronounce the sound of concealed vowel “A”. Then student can proceed in decoding the next word 203b.

FIG. 6B illustrates revealing middle-vowel phoneme 301 in a two-step vowel priming method. First, middle-vowel grapheme 206 in the middle of word 203b is revealed, which in this example is an “i.” Next, the student is given a period of time to decode grapheme 206 to produce vowel phoneme 301. In such scenario, the student can form the sound “\check{1}”.

FIG. 6C illustrates revealing the beginning and ending consonant graphemes 206 in a two-step vowel priming method. In a next step, consonant grapheme 206 to the left of middle-vowel grapheme 206 and consonant grapheme 206 to the right of middle-vowel grapheme 206 can be revealed together, which in this example are “b” and “g,” respectively. Then, the student can be given another period of time to decode the ending consonant phoneme 302. Such decoding can include pronouncing all three phonemes 204 together to read word 203b. As such the student can connect sound “/\check{1}/” with revealed consonant phonemes 302 “/b/” and “/g/” forming the sound “/b\check{1}g/”. By this time, the student can completely read and decoded first word 203a “A” and second word 203b “big”.

FIG. 6D illustrates revealing middle-vowel grapheme 206 of word 203c in a two-step vowel priming method. In this example, word 203c also comprises consonant grapheme 206 preceding and following middle-vowel grapheme 206 “o”, the two consonant phonemes 204 hidden. Similarly, time can be given to allow the student to decode “o” before continuing to reveal more of story 202.

FIG. 6E illustrates revealing the beginning and ending consonant grapheme 206 of third word 203c as part of a two-step vowel priming method. In a next step, consonant phoneme 302 to the left of vowel phoneme 301 and consonant phoneme 302 to the right of vowel phoneme 301 can be revealed together, which in this example is a “d” and “g,” respectively. Then, the student can be given another period of time to decode the ending consonant phoneme 302. Such decoding can include pronouncing all three phonemes 204 together to read word 203b. As such the student can connect sound “/\check{o}/” with revealed consonant phonemes 302 “d” and “g” forming the sound “/d\check{o}g/”. By this time, the student can completely read, “A big dog”.

In one embodiment, a first subset of one or more subsets can comprise all remaining graphemes 206a, wherein word 203 is revealed in a two-step vowel priming method. In the examples discussed above for two-step vowel priming method for word 203 “dog”, the first subset of one or more subsets is consonant phonemes 302 “d” and “g”. Meanwhile for multi-step vowel priming method for the same word 203 “dog”, one or more subsets for remaining graphemes 206a can comprise two or more subsets. Using the same word example “dog”, the first subset can comprise consonant phoneme 302 “d” and the second subset can comprise consonant phoneme 302 “g”.

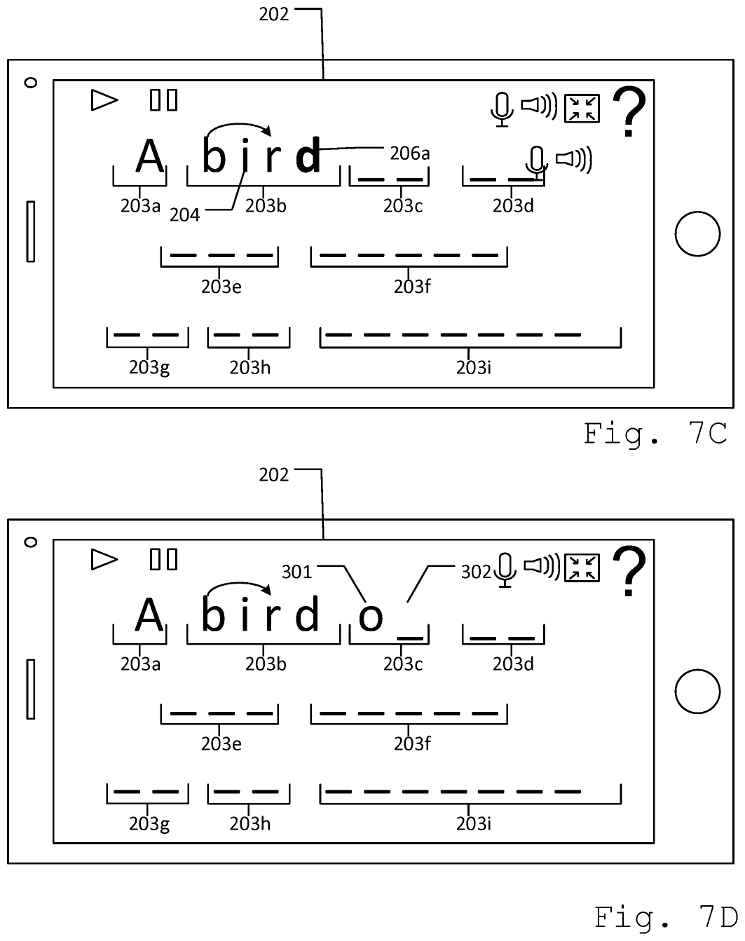

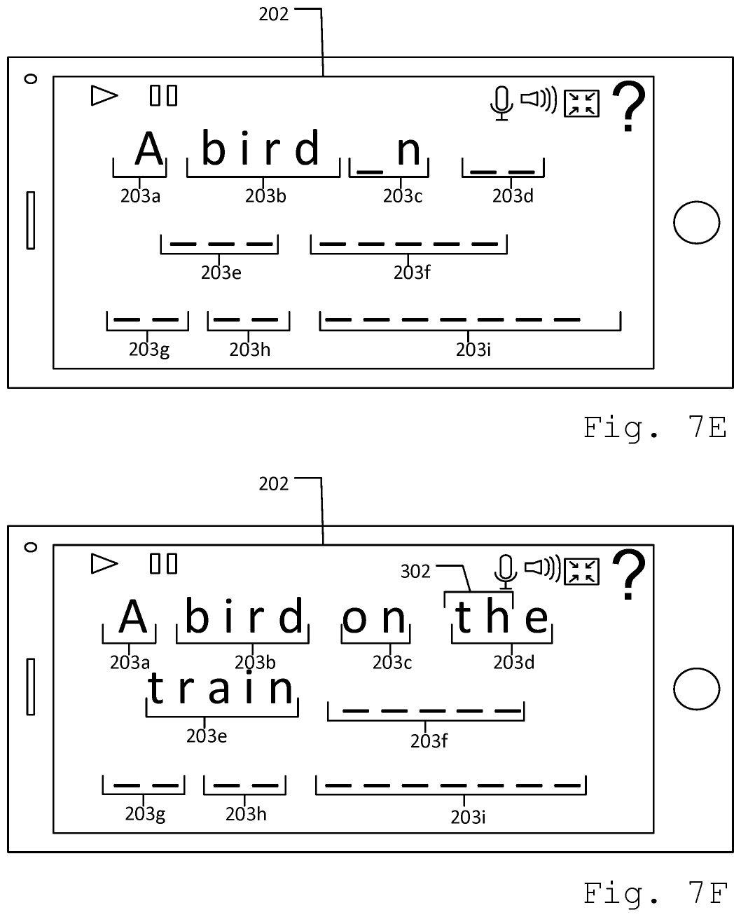

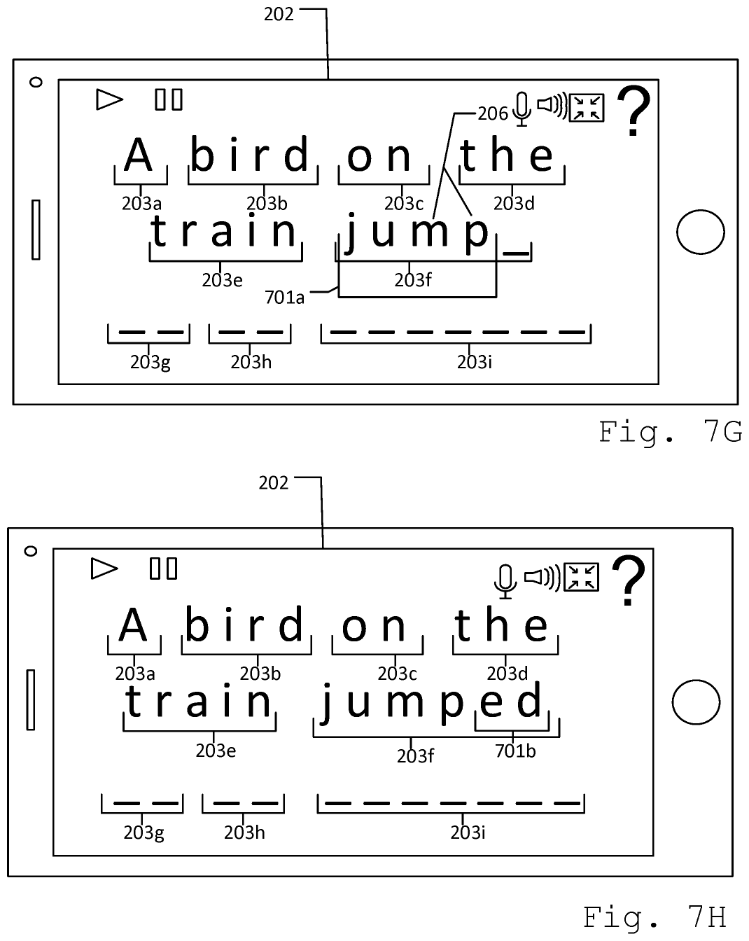

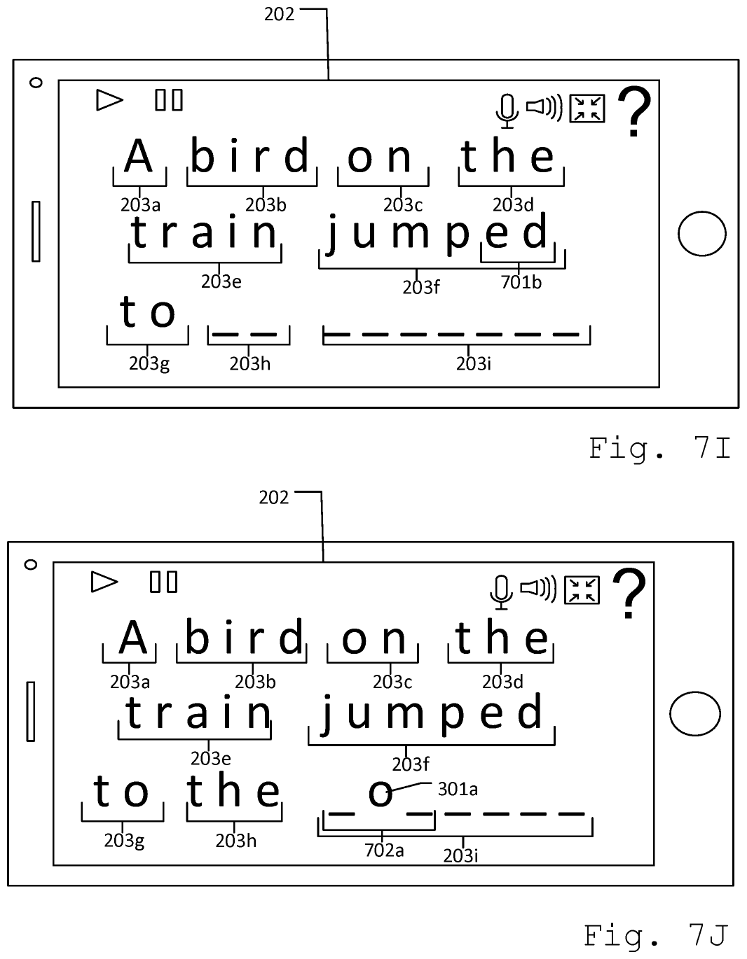

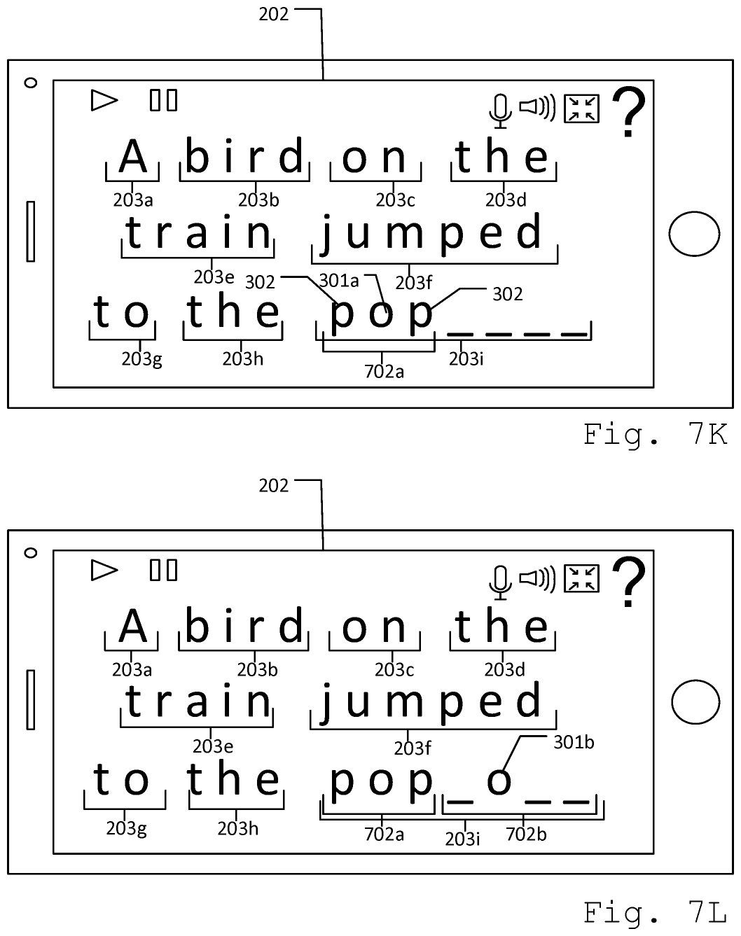

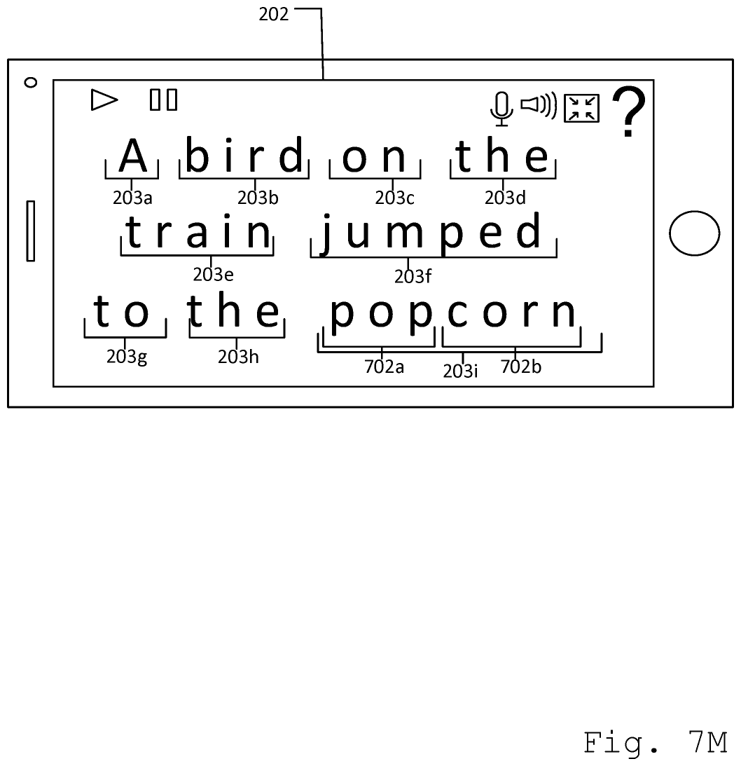

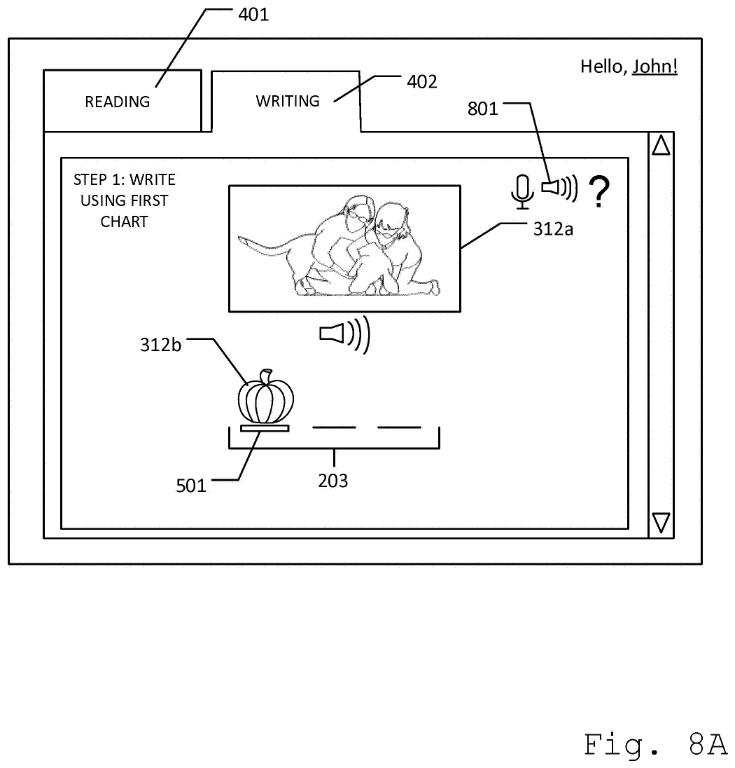

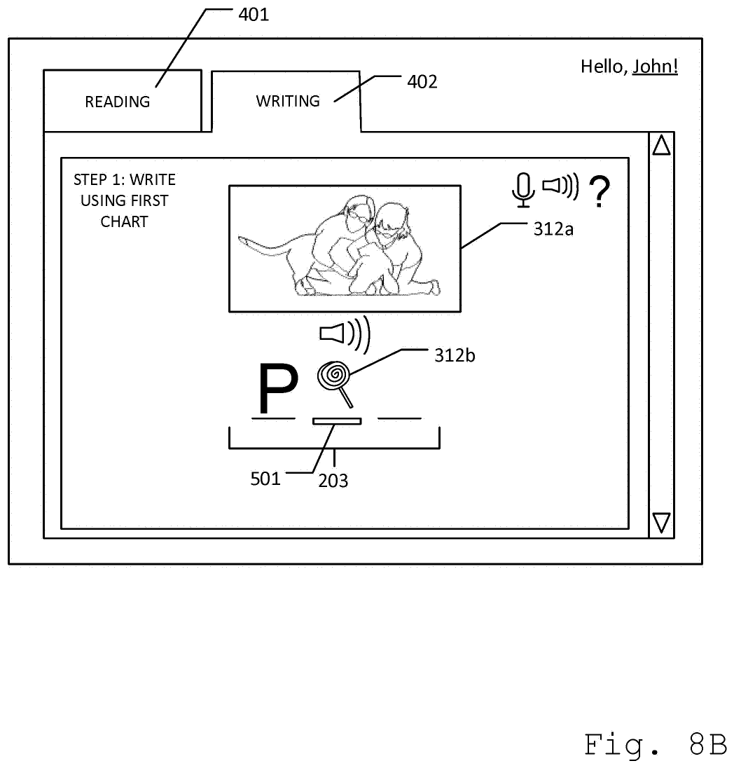

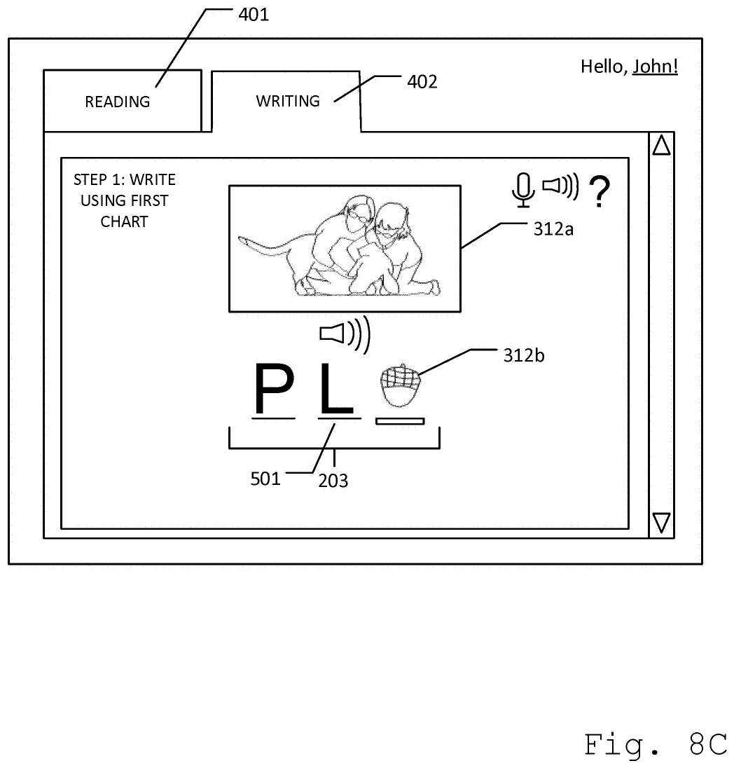

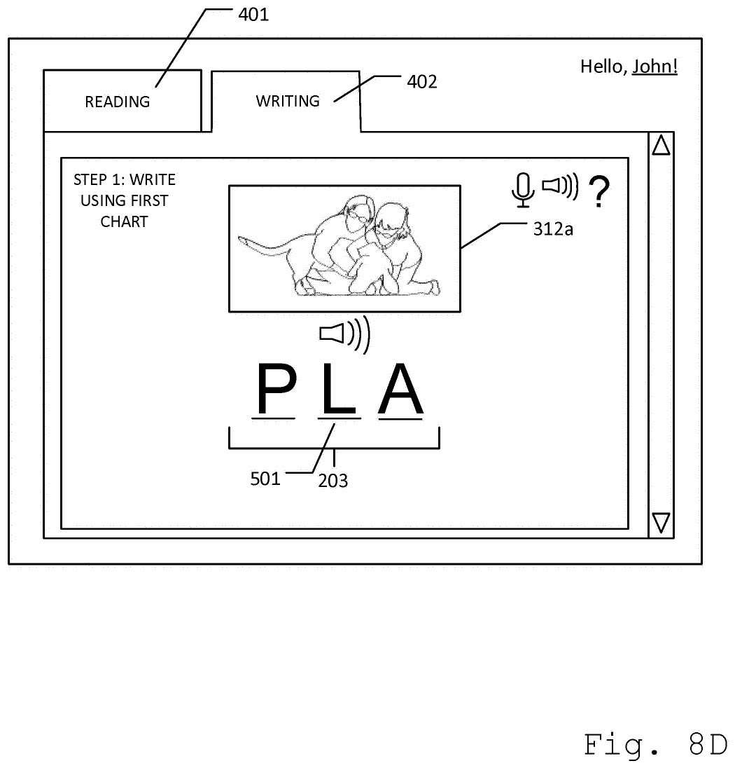

FIGS. 7A-7M illustrate story 202 within reading routine 401 illustrating more advanced techniques in a vowel-priming method, using graphemes from a plurality of charts 300.

FIG. 7A illustrates story 202 beginning with word 203 consisting of one phoneme 204. In this example story 202, story 202 comprises multiple words 203. Similar as above, first word 203a “A” is decoded by the student.

FIG. 7B-7C illustrate an r-controlled vowel method.

FIG. 7B illustrates a first step in one embodiment of an r-controlled vowel method. Within the English language, there exist a set of graphemes 206 that all represent phoneme 204 “/∂r/.” Examples of such grapheme 206 include “er”, “ir”, “or”, “ur”, and “ear”. Some examples of words 203 that follow the r-controlled vowel method can include but is not limited to “fern”, “firm”, “worm”, “burn”, and “learn.” For purposes of this disclosure, an r-controlled vowel refers to grapheme 206 “r” that is preceded by a short vowel.

In one embodiment, as shown in FIG. 7B, reading routine 401 can comprise revealing beginning consonant grapheme 206 “b” simultaneously consonant grapheme 206 “ir.”

FIG. 7C illustrates an embodiment of second word 203b completely revealed. Once the student forms the sound “/b r/”, a remaining grapheme 206a “d” can be displayed. Now, the student can phonemes 204 “/ b ∂r/” following the r-controlled vowel method to consonant phoneme 302 “d” and decode second word 203b “/bard/” as in “bird”. Finally, phoneme 204 “i” can be revealed. At this point, the student can completely read “A bird.”

In another embodiment, the r-controlled vowel method can use a vowel priming method. In such embodiment, the student can be shown vowel grapheme 206 “ir” while “b” and “d” are hidden. Next, after a period of time, using a three-step vowel priming method, “b” can then be revealed. Then the “d” can be revealed. In another embodiment, after a period of time, using a two-step vowel priming method, graphemes 206 “b” and “d” can be revealed together.

In another embodiment, a student can first be shown grapheme 206 “b.” Next, grapheme “r” can be revealed while grapheme “i” can remain hidden. Then “d” can be revealed. Finally, the entire word can be shown.

In another embodiment, “b” can be displayed. Then “ir” can be displayed. Then “d” can be displayed.

In any of these embodiments, vowel grapheme 206 can comprise a vowel grapheme. In such embodiments, vowel grapheme can comprise a visual characteristic 700 that can be distinctive from said controlling r. As such, the “i” can be represented in a visually different manner than letters “b”, “r”, and “d” to signify that the “i” is not pronounced on its own. Examples of visual characteristic 700 can include varying its color as compared to the other letters, such as greying it out, using a smaller font, italics, etc. In another embodiment, visual characteristic 700 can be an arrow. The arrow can be placed on top of consonants 302 “b” and “r” to indicate “jump over” or skip the short vowel phoneme 307 preceding grapheme 206

FIGS. 7D-7F illustrate another method for revealing graphemes 206 that starts with a vowel phoneme 301.

FIG. 7D illustrates a method for revealing graphemes 206 that start with a vowel phoneme 301. In a preferred embodiment, words that start with a vowel can be displayed by first showing the vowel phoneme then leaving remaining graphemes 206a hidden. Then, pause to allow user to decode vowel phoneme 301. In such embodiment, only vowel phoneme 301 “o” can be displayed on the screen. In another embodiment, words 203 that start with vowel phoneme 301, such as “on”, “an”, “or”, “end”, and “and” can be entirely displayed on the screen at once.

FIG. 7E illustrates a next step in a method for revealing graphemes 206 that starts with a vowel phoneme 301. As illustrated, after revealing vowel grapheme 206 “o” and allowing the student to decode vowel phoneme 301, vowel grapheme “o” can be hidden again and then consonant grapheme 206 “n” can be displayed. Such method can prevent the student to read the words forward and then backwards, for example reading word 203c as “ono”. Moreover, this method can prevent the student to read word 203c backwards, for example reading word 203c “on” as “no”. The student can then be given enough time to decode grapheme 206 “n”.

FIG. 7F illustrates word 203c that starts with a vowel phoneme 301 completely revealed. The entire word 203c can be completely displayed after the student completely decoded word 203c “on”. The next word 203d “the” can then be revealed using the vowel priming method, as discussed above. At this time the student can completely decode fourth word 203d. The student can then continue decoding fifth word 203e using any of the methods described above.

FIGS. 7G- 7H illustrate decoding a sixth word 203f, sixth word 203f comprising a root word and a suffix.

FIG. 7G illustrates revealing word 203 comprising a root word 701a and a suffix. In first steps, root word 203f can be decoded using any of the methods described above. In one embodiment, consecutive consonant graphemes 206 “j”, “m” and “p” can be revealed simultaneously. In another embodiment, “j”, “m” and “p” can be revealed separately with a period of time in between, as described above.

FIG. 7H illustrates revealing a suffix “ed” 701b of seventh word 203f After root word 203f is disclosed, a period of time can be given to allow the student to decode root word 701a, as described above. Next, suffix 701b can be revealed, and time can be given for the student to decode word 203 “jumped.”

FIG. 71 illustrates a non-phonetic word 203g “to”. In this case, the spoken word of word 203g is “/tu/” while the conventional spelling of word 203g is encoded as “to.” In such case, word 203g does not match any of charted grapheme-phoneme pair within the set of charted grapheme-phoneme pairs. Moreover, chartered grapheme 206 “o” on set of chartered graphemes 206 are associated with charted phonemes 204 “o” that sounds like \check{o}-ctopus or \check{o}-cean only, and there is no grapheme-phoneme pair for charted phoneme 204 “/u/” and grapheme 206 “o” together. As “to” cannot be completely constructed using grapheme-phoneme pairs, word 203 “to” can be considered as non-phonetic word. On the other hand, other words 203 that can match at least one of charted grapheme-phoneme pair can be considered as phonetic word. Some examples of phonetic words are illustrated and discussed in FIGS. 7A-7H. Further in this embodiment, non-phonetic word 203g “to” can be displayed contemporaneously and the student can be given enough time to decode word 203g and prompted to pronounce the word wrong. The instructor or learning application 103 can then correct the pronunciation of the word “to”. In an embodiment wherein the student can be using learning application 103, a voiceover can tell the student the correct pronunciation of the word “to” through playing an audio file. In a preferred embodiment, the student should decode non-phonetic word 203g on his or her own. This can allow the student to connect his phonetic mispronunciation of the word to the correct pronunciation. In this way, when the student mispronounces “to” in the future, it will ring a bell and the student will remember the correct pronunciation and self-correct.

FIGS. 7J-7M illustrate decoding a compound word 203i.

FIG. 7J illustrates revealing grapheme 206 representing a middle-vowel phoneme 301a of first word 203 of compound word 203i. Compound word 203i is made up of two or more words 203. In this embodiment, a vowel priming method can be applied for each word 203 from left-to-right of compound word 203i. In this example scenario, middle-vowel grapheme 206 “o” from first word 203 is displayed first. Once the student decodes grapheme 206 “o” to produce vowel phoneme 301 “/o/”, the student can click continue button 502 to display graphemes for first word 203 of compound word 203i.

FIG. 7K illustrates revealing graphemes 206 representing consonant phonemes 302 of first word 203. Similar to the previous reading routine 401, the student can attach decoded vowel phoneme 301 “/o/” with both decoded consonant phonemes 302 “p” to form the sound “/p o p”.

FIG. 7L illustrates revealing grapheme 206 representing vowel phoneme 301 of second word 203 of compound word 203h. After decoding first word 203, middle-vowel grapheme 206 “o” for second word 203 can be revealed. As such, the student can form vowel phoneme 302 “/o/” and continue decoding the reset of second word 203 pursuant to a vowel priming method.

FIG. 7M illustrates revealing graphemes 206 representing consonant phonemes 302 of second word 203. Using methods described above, graphemes 206 representing consonant phonemes 302 can be displayed.

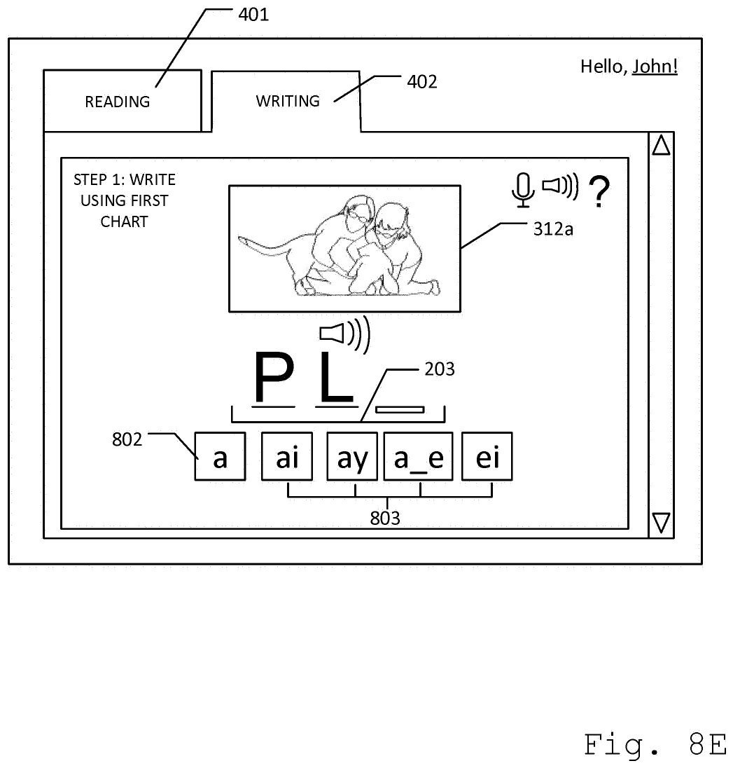

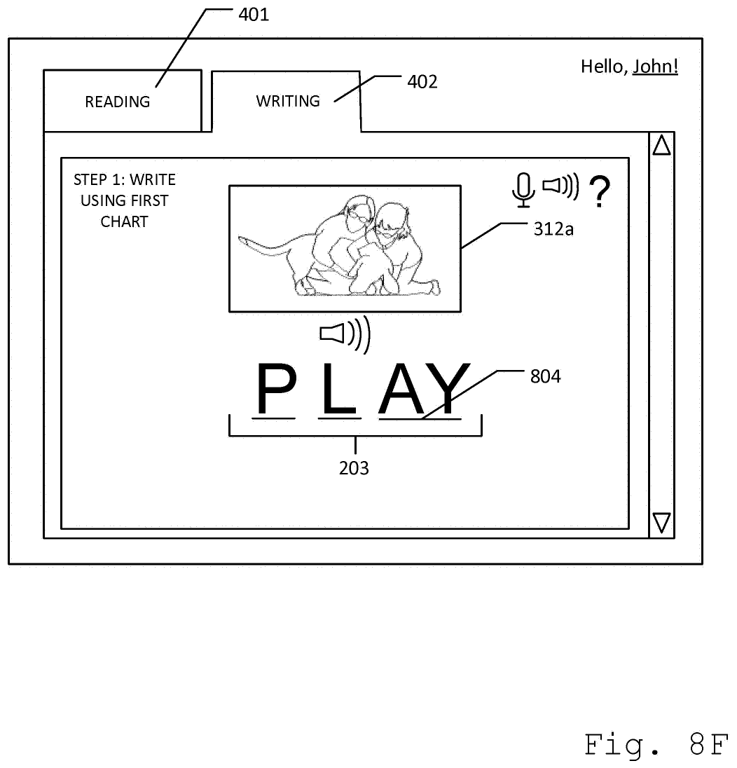

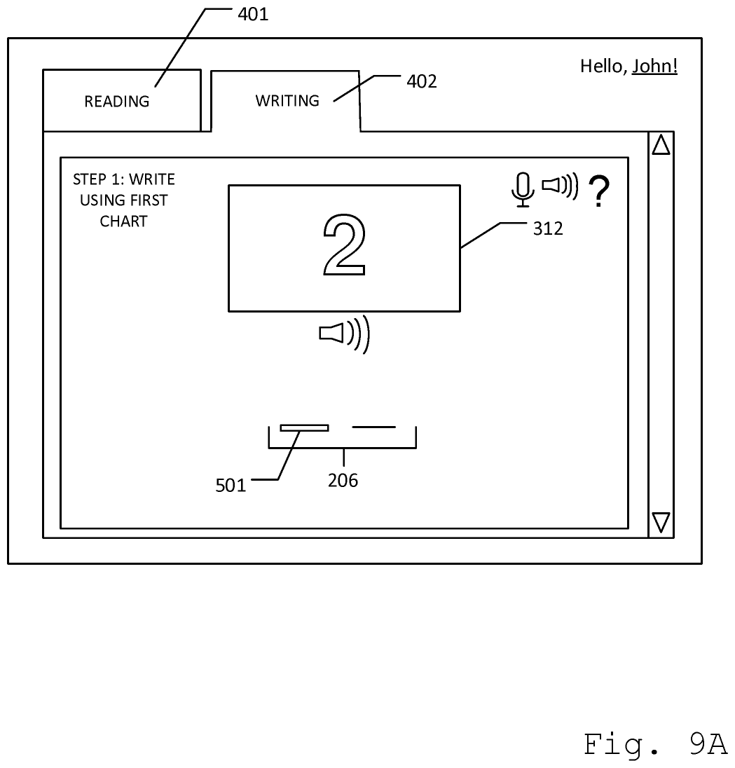

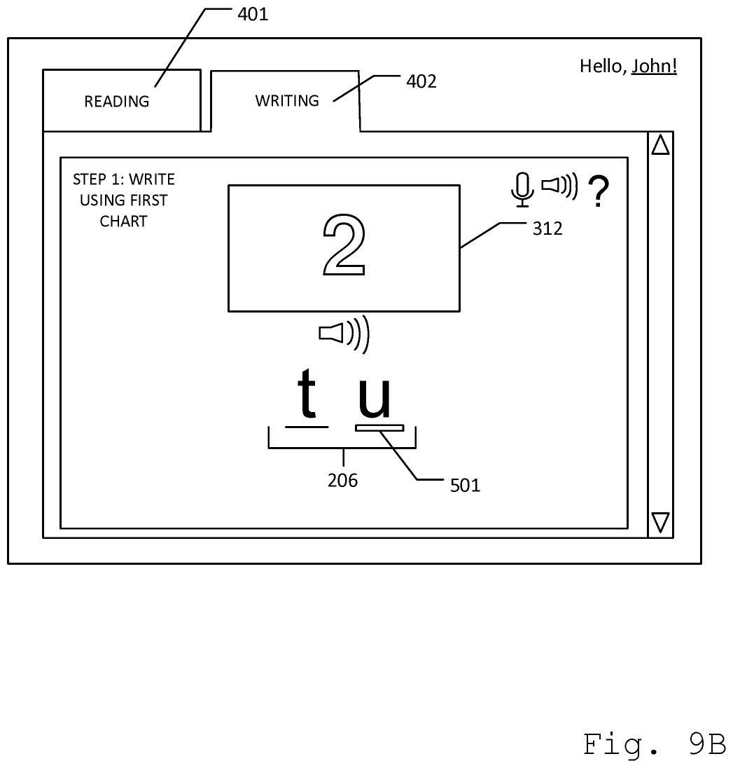

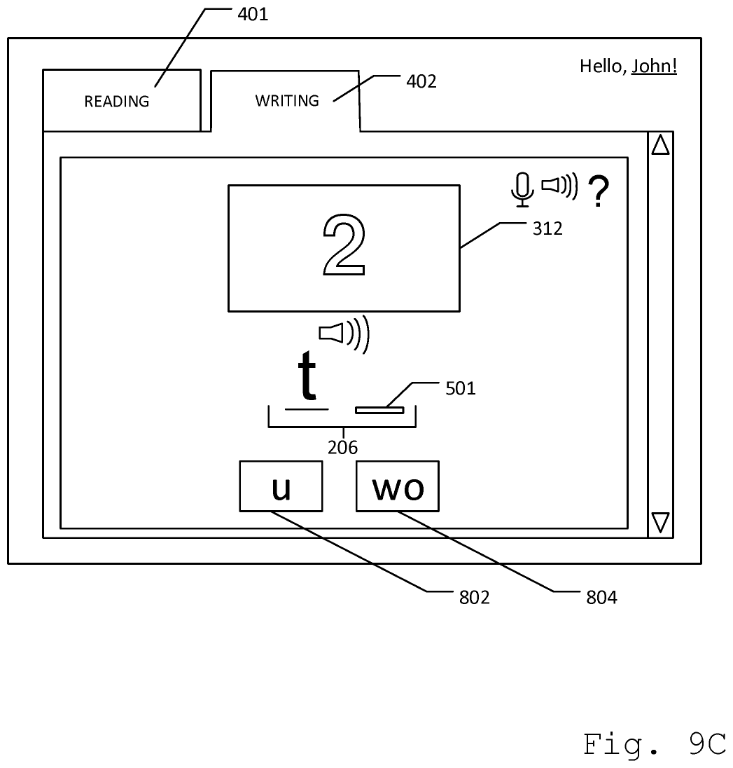

FIG. 8A-8D illustrate a method of teaching to write phonetic word 203 using first chart 300ab.

Using all or portions of reading routine 401, the student can associate graphemes 206 with phonemes 204. Further, the student will begin to recognize, as well as be taught by an instructor or by learning application 103 certain guiding principles for how certain graphemes 206 are used on a language. While often times the particular sound of word 203 could feasibly be represented by many different graphemes 206, nearly all (but admittedly not all) words 203 are represented by a single ordered combination of graphemes 206, such referred to hereinafter as a conventional spelling. Changes to graphemes 206 to a nonconventional spelling often result in word 203 either becoming a different word, or simply being considered an incorrect spelling. For example, the word “maid” if spelled “made” results in a different word altogether, and if spelled “mayd” would be considered an incorrect spelling.

Writing routine 402 can be used to reinforce guiding principles within a language while also teaching the student conventional spellings of words 203. Generally speaking, a preferred embodiment of writing routine 402, comprises a plurality of steps. In a first step, word 203 is communicated to the student in any method known in the art other than in its written form, and the student is presented with generic symbols 501 arranged consecutively, each generic 501 symbol representing one grapheme 206 of word 203, and all graphemes 206 of word 203 represented by one of the plurality of generic symbols 501. In one embodiment, word 203 can be communicated to the student either by an instructor or by learning application 103. Communication of word 203 can be audibly communicated or visibly communicated using a representative image of word 203.

In a next step, the student can be prompted to encode by choosing grapheme 206 from first chart 300a for each generic symbol 501 to create a phonetically accurate spelling of word 203 even if it is impossible to spell word 203 using a conventional spelling of word 203 with first chart 300ab. In one embodiment, writing routine 402 the student can be prompted to choose graphemes 206 for generic symbols 501 in order of a vowel priming method. In another embodiment, the student can be prompted to choose graphemes 206 for generic symbols 501 for consonant phonemes 302 first, followed by grapheme 206 for generic symbols 501 for vowel phoneme 301 between the consonant phonemes 302. In a preferred embodiment, the student can be prompted to choose graphemes 206 for generic symbols 501 in order of pronunciation when saying word 203.

FIG. 8A illustrates encoding phoneme 204 of phonetic word 203 in an example of an embodiment of writing routine 402. Initially, the instructor or learning system 100 can communicate word 203 to the student in any manner other than a written form of the said word. In one embodiment, the instructor can communicate word 203 to the student by audibly communicating or speaking word 203. In another embodiment, learning application 103 can communicate word 203 or each phoneme 204 of word 203 to the student through a speaker 801. Further in another embodiment wherein learning system 100 can be used, word 203 can be communicated to the student by displaying representative image 312a of word 203. Further, a spoken word of phonetic word 203 can comprise set of phonemes 204 arranged in an order such that when set of phonemes 204 is spoken, the set of phonemes 204 can form the spoken phonetic word. In this example, the student is asked to encode word “PLAY” using only graphemes 206 from first chart 300ab. In the example, the student is prompted first to encode each phoneme 204 of set of phonemes 204 with grapheme 206 “P.” The student can be prompted to choose grapheme 206 in any method known in the art. Examples of prompting the student to encode each phoneme 204 can include, but are not limited to an auditory prompt such as audibly communicating each phoneme 204 through speaker 801 or through a spoken word, or a visual prompt such as changing one generic symbol 501 of generic symbols 501 related to word 203, the visual change unrelated to grapheme 206. In one embodiment, the visual prompt can comprise showing representative image 312b of each phoneme 204 to the student. In learning application 103 the prompts (auditory or visual) can prompt the student automatically or occur upon some input from the student, such as by clicking on a button or by physically writing graphemes 206 on generic symbols 501 using an input device such as an Apple pencil or a stylus to engage in writing in the purist form.

The student can encode grapheme 206 in a number of ways including but not limited by saying grapheme 206, typing grapheme 206, or selecting grapheme 206 from a set or a first plurality of graphemes 206 from first chart 300ab. For purposes of this disclosure, the first plurality of graphemes 206 together can phonetically form word 203. With regard to learning application 103, choosing can be performed using any method known in the art such as by clicking on a choice of a plurality of choices offered, or navigating to first chart 300a and clicking on a choice.

FIG. 8B illustrates encoding another phoneme 204 in word 203. In the illustrated example, after grapheme 206 “P” is selected, the student can then be prompted to encode phoneme 204 /L/ in “PLAY” by choosing another grapheme 206 “L” from first chart 300a, as described above.

FIG. 8C illustrates encoding the final phoneme 204 in word 203. In the illustrated example, after grapheme 206 “L” is selected, the student can then be prompted to encode phoneme 204 /ā/ in “PLAY” by selecting another grapheme 206 from first chart 300a, as described above. Thus, the instructor or learning system 100 can receive first selections of graphemes 206 that can form set of graphemes 206 in the order wherein when set of graphemes 206 is spoken, the set of graphemes can form the spoken word “play”. However, in first chart 300a as shown in FIG. 3B, the only grapheme 206 representing “/ā/” is grapheme 206 “a”. As such, first plurality of graphemes 206 is missing a necessary grapheme 206 “ay” to form a conventional spelling of word 203 “play”. In such instance, the student can select “a” to form an unconventional group of graphemes 206 and form a phonetic representation of word 203 “PLAY.”

FIG. 8D illustrates word 203 completely encoded using graphemes 206 from first chart 300ab. In the illustrated example, graphemes 206 can be displayed in the order associated with the first selections made by the student. However, the order of graphemes 206 that is associated with first selections “PLA” forms an unconventional spelling for the word “PLAY.”

FIG. 8E-8F illustrate additional method steps of the method of teaching the student to write phonetic word 203 using an additional chart 300. Words 203 comprising graphemes 206 not on first chart 300a cannot be conventionally spelled using only first chart 300ab.

FIG. 8E illustrates removing a grapheme 206 incongruent with the conventional spelling of word 203. In one embodiment, the instructor or learning application 103 can show the student which grapheme 206 is incongruent from the conventional spelling of word 203 “PLAY”. As shown in FIG. 8E, grapheme 206 “a” can be removed from the student's encoded word, which can now be a removed grapheme 803. In a preferred embodiment, removed grapheme 803 can be hidden from screen and can no longer be selected when encoding a missing grapheme 206. In one embodiment, the student can be prompted to encode phoneme 204 that is missing or no longer encoded. As illustrated, the student can select a replacement grapheme 804 from a second plurality of graphemes 803 wherein the replacement grapheme 804 can be associated with a chart other than first chart 300ab. In this embodiment, second plurality of graphemes 803 provided to the student can be based from second chart 300b and third chart 300c of grapheme family 310 of common homophone 309 of long-vowel phoneme 308 “a”. In this example, second plurality of graphemes 803 provided to the student can comprise “ai”, “ay”, “ey”, “a_e”, and “ei”. Such method can guide the student on how to make appropriate substitutions for long-vowel phoneme 308 “a”.

FIG. 8F illustrates incongruent grapheme 206 “a” replaced with the appropriate replacement grapheme 804 “ay” for conventional spelling. As such, a second selection made by the student can display replacement grapheme 804 “ay” is in place of a removed grapheme 802 “a”, which now forms the conventional spelling of word 203 “play”. For purposes of this disclosure, the student can learn to make appropriate substitution when spelling words 203 as the student encounters words from reading routine 401 and writing routine 402.

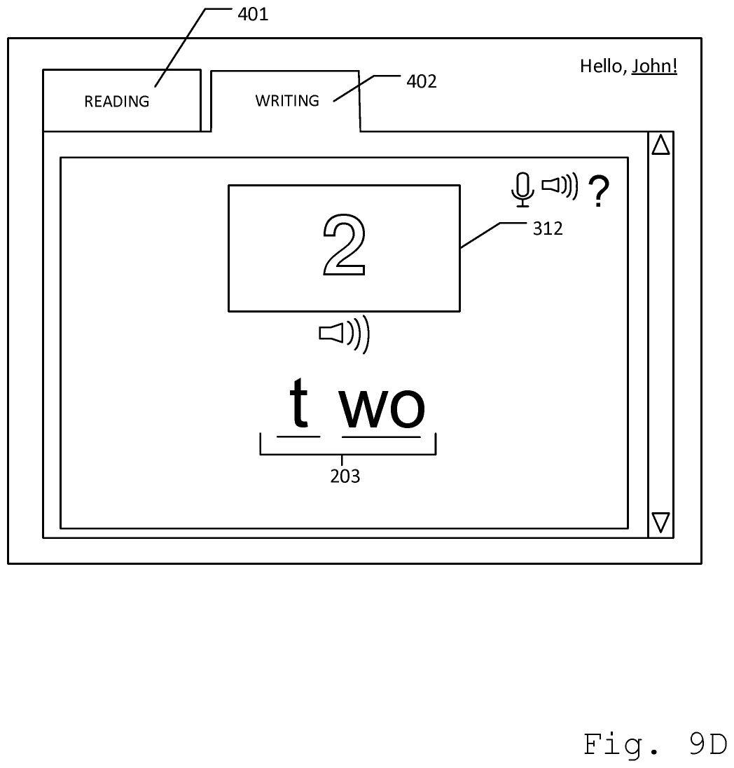

FIG. 9A-9B illustrates a method of teaching to write a non-phonetic word.

FIG. 9A illustrates encoding phoneme 204 of non-phonetic word 203 in an example of an embodiment of writing routine 402. Learning system 100 can first communicate to the student word 203 to the student in a manner other than a written form of the said word 203. In this embodiment, word 203 can be a non-phonetic word.

First, the student is prompted to encode each phoneme 204 of set of phonemes 204 with grapheme 206. In this example, the student can perform the encoding by selecting grapheme 206 “T” from a first plurality of graphemes 206, wherein the first plurality of graphemes 206 from charted graphemes 315.

FIG. 9B illustrates encoding phonemes 204 in word 203. In this example, after the student selects grapheme 206 “t”, the student can be prompted to select phoneme 204 “/u/”. In one embodiment, the student can select another grapheme 206 from first chart 300ab. In this example embodiment, the student can select phoneme 204 “u” (as in flu). Thus, learning system 100 can receive first selections of graphemes 206 that form the set of graphemes 206 in the order wherein when set of graphemes 206 is spoken, the set of graphemes can form the spoken word “two”. Set of graphemes 206 associated with the first selections can then be displayed in the order it was encoded. Set of graphemes can form the spelling of word 203. In this example embodiment, first selections of graphemes 206 “tu” can be an unconventional spelling of the spoken word “two”.

FIG. 9C-9D illustrates additional method steps of the method of teaching the student to write non-phonetic word 203.

FIG. 9C illustrates removing a grapheme 206 that is incongruent with the conventional spelling of a non-phonetic word. In one embodiment, learning system 100 can show the student which grapheme 206 is incongruent from the conventional spelling of non-phonetic word “two”. As shown in FIG. 9C, grapheme 206 “u” can be removed from the student's encoded word. As such in one embodiment, each phoneme 204 that was previously encoded with a removed grapheme 802 “u” can no longer be encoded.

In one embodiment, the student can be prompted to encode phoneme 204 that is missing or no longer encoded. In a preferred embodiment, after grapheme 206 “u” is removed, the student can select one or more replacement letters 804 “wo”. Replacement letters 804 are not representing grapheme family member 310b (that are “oo”, “ew”, “ue”, “ui”, “ou”, and “u_e”) of removed grapheme 802 “u”. In this embodiment, the student can learn that “wo” is the appropriate replacement grapheme to form the conventional spelling of the spoken word “two”. In another embodiment, the student can select replacement grapheme 804 from second plurality of graphemes 803 wherein replacement grapheme 804 can be associated with a chart other than first chart 300ab.

FIG. 9D illustrates incongruent grapheme 206 “u” replaced with one or more replacement letters 804 for each removed grapheme 802. Replacement letters 804 does not represent grapheme family member 310b of removed grapheme 802 “u”. As such, the student can make a second selection that can display replacement letters 804 “wo”, in place of the removed grapheme 802 “u”, which can now form the conventional spelling of the spoken word “two”. After receiving replacement letter selections from the student, the learning system can display in place of each removed grapheme 802 the replacement letters that form the conventional spelling of word 203 “two”.

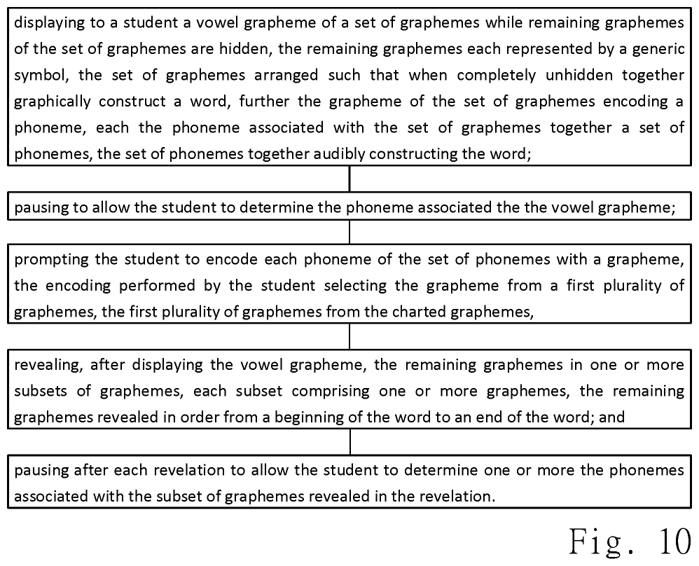

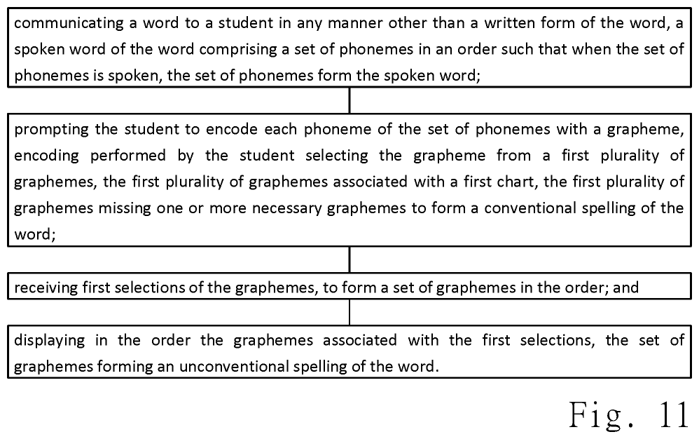

FIG. 10 illustrates an exemplary method of teaching a student how to read using a vowel priming method. Initially, each grapheme on set of graphemes 206 can be hidden from a student. Each hidden grapheme 206 of set of graphemes 206 can be represented to the student by displaying generic symbol 501 for each hidden grapheme 206. Furthermore, each grapheme 206 of the set of graphemes encodes phoneme 204 wherein each phoneme 204 can be associated with the set of graphemes 206 that together forms a set of phonemes 204. The set of phonemes together can audibly construct word 203.

The student can first be provided with a set of charted grapheme-phoneme pairs. Learning system 100 can then present to the student words 203 in story 202 in order of the story. Each word 203 can be a phonetic word, or a non-phonetic word. The story can comprise on or more phonetic words 203 and one or more non-phonetic words, which can be presented as discussed herein. For each phonetic word 203, a first subset of graphemes 206 of a set of graphemes 206 can be displayed while remaining graphemes 206a of the set of graphemes 206 can be hidden. The set of graphemes 206 can be arranged such that when each grapheme 206 of the set of graphemes 206 is unhidden, the set of graphemes 206 together can graphically construct the phonetic word 203. Further, the first subset of grapheme 206 can comprise one or more of the said graphemes 206.

As such, a vowel grapheme 206 of a set of graphemes 206 can be displayed while remaining graphemes 206a can be hidden. In an embodiment wherein learning system 100 is on electronic device 105, remaining graphemes 206a can be displayed or replaced with generic symbol 501 such as an underscore or asterisk. In another embodiment wherein learning system 100 uses cards 500, remaining graphemes 206a can be shown to the student faced down.

After revealing vowel grapheme 206, learning system 100 can pause to allow the student to decode a first subset of phonemes 204 that is associated with vowel grapheme 206, which can be encoded with first subset of graphemes 206. The user can then pronounce the vowel grapheme and learning system 100 can reveal the remaining graphemes in one or more subsets of graphemes. The remaining graphemes 206a can be revealed in order from a beginning of word 203 to an end of word 203, wherein learning system 100 can pause after each revelation.

In an embodiment wherein a two-step vowel priming method can be used, a first subset of one or more subsets can comprise all remaining graphemes 206a, Using an example word 203e “train” in FIG. 7F, remaining graphemes 206a for the two-step vowel priming method can comprise the first subset that can comprise consonant phoneme 302 “r” and “n”, in one embodiment. The consonant phonemes “r” and “n” can be displayed after displaying vowel phoneme 301 “ai”, while the other subset of one or more subsets can comprise consonant phoneme 302 “t” that can be displayed after displaying first subsets “r” and “n”. In another embodiment, the first subset can comprise consonant phonemes 302 “tr” and “n”. In such embodiment first subset can be all of graphemes 206. Further, using the same word example “train” in revealing words using a multi-step vowel priming method, one or more subsets can comprise a subsets for each consonant phoneme 302 “t”, “r”, and “n”. In this embodiment, each subset is displayed one by one using the multi-step vowel priming method. In these embodiments, learning system 100 can pause after each revelation to allow the student to decode a subset of phonemes 204 associated with the subset of graphemes 206 revealed in the revelation. Further, for each non-phonetic word, all letters of non-phonetic word can be displayed contemporaneously.

FIG. 11 illustrates an exemplary method of teaching a student how to write using a plurality of charts 300. Initially, a set of generic symbols 501 can be displayed to a student. Each generic symbol 501 of the set of generic symbols can represent one phoneme 204 from a set of phonemes 204. To begin, an instructor or learning application 103 can communicate word 203 to the student in any manner other than a written form of the said word. The spoken word of word 203 can comprise a set of phonemes 204 arranged in an order such that when said set of phonemes 204 is spoken, the set of phonemes 204 can form the spoken word. Word 203 can be communicated to the student through auditory or visual prompts, as discussed above. In one embodiment, representative image 312 can be communicated to the student to represent word 203. Such embodiment can be shown in FIGS. 8 wherein representative image 312 shows a picture of individuals playing. Learning system 100 can then prompt the student to encode each phoneme 204 of set of phonemes 204 with grapheme 206. In one embodiment, each phoneme 204 can be communicated to the student by displaying representative image 312 for each phoneme 204 that can be associated with each generic symbol 501. This embodiment can be shown in FIGS. 8A- 8C wherein generic symbols 501 can be displayed with representative image 312 that represents each hidden phoneme 204 of sets of phonemes 204. The student can perform the encoding by selecting grapheme 206 from a first plurality of graphemes 206 to form set of graphemes 206 in the order that each phoneme 204 is spoken. The first plurality of graphemes can be associated with first chart 300ab. In such method, first plurality of graphemes 206 can be missing one or more necessary graphemes to form a conventional spelling of said word since graphemes 206. This method can be necessary to allow the student to learn how to write words 203 phonetically. Next, the learning system can receive first selections of graphemes 206 that the student selected and learning system 100. Learning system 100 display graphemes 206 in the order it was received. The displayed graphemes 206 can be associated with first selections of the student, wherein the displayed graphemes 206 form the set of graphemes 206 that form an unconventional spelling of said word. In the next method, learning system 100 can allow the student to learn the accurate phonetic spelling of word 203. To start, each grapheme 206 that can be incongruent with the conventional spelling of word 203 can be removed from the display. As such, each phoneme 204 that was previously encoded by the student with a removed grapheme 802 can be no longer encoded. Next, learning system 100 can prompt the student to encode each phoneme 204 that is no longer encoded, by allowing the student to select replacement grapheme 804 from second plurality of graphemes 803. Each of the replacement grapheme 804 can be associated with a chart other than first chart 300ab. Learning system 100 can then receive a second selection of replacement grapheme 804 for each removed grapheme 802. Lastly, the learning system can display in place of each removed grapheme 802 the replacement grapheme 804 to form the conventional spelling of word 203.

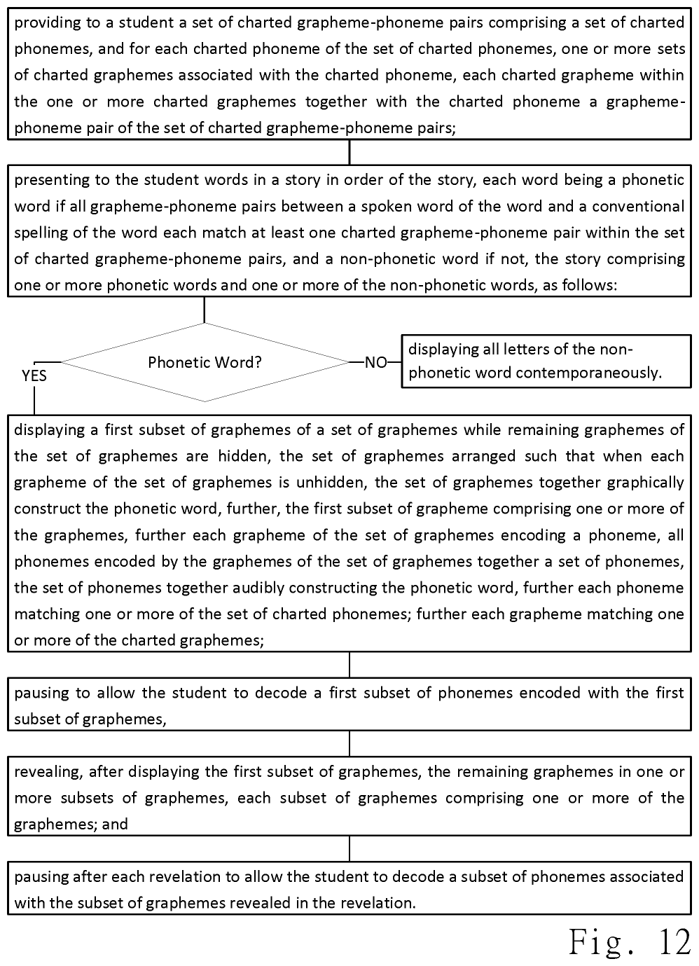

FIG. 12 illustrates an exemplary embodiment of teaching a student to read using a phonetic word distinction technique. The method can comprise the step of providing to a student a set of charted grapheme-phoneme pairs. The set of charted grapheme-phoneme pairs can comprise a set of charted phonemes, and for each charted phoneme of the set of charted phonemes, one or more sets of charted graphemes can be associated with the charted phoneme. Each charted grapheme that can be within the one or more charted graphemes together with the charted phoneme can be a grapheme-phoneme pair of the set of charted grapheme-phoneme pairs. The method can also comprise the step of presenting to the student words in a story in order of the story. Each of the word being a phonetic word if all grapheme-phoneme pairs between a spoken word of the word and a conventional spelling of the word each match at least one charted grapheme-phoneme pair within the set of charted grapheme-phoneme pairs, and a non-phonetic word if not. The story can comprise one or more of the phonetic words and one or more of the non-phonetic words. The words in the story can be presented as follows, for each of the phonetic word, the method can comprise the step of displaying a first subset of graphemes of a set of graphemes while remaining graphemes of the set of graphemes are hidden. The set of graphemes can be arranged such that when each grapheme of the set of graphemes is unhidden, the set of graphemes together can graphically construct the phonetic word. Further, the first subset of grapheme can comprise one or more of the graphemes. Further each of the grapheme of the set of graphemes can encode a phoneme. All of the phonemes can be encoded by the graphemes of the set of graphemes together a set of phonemes. The set of phonemes together can audibly construct the phonetic word. Further, each of the phonemes can match one or more of the sets of charted phonemes. Each of the graphemes can match one or more of the charted graphemes. Moreover, the method can comprise the steps of pausing to allow the student to decode a first subset of phonemes encoded with the first subset of graphemes, and revealing, after displaying the first subset of graphemes, the remaining graphemes in one or more subsets of graphemes. Each of the subset of graphemes can comprise one or more of the graphemes. Additionally, the method can comprise the step of pausing after each revelation to allow the student to decode a subset of phonemes associated with the subset of graphemes revealed in the revelation. Furthermore, for each of the non-phonetic word, the method can comprise the step of displaying all letters of the non-phonetic word contemporaneously.

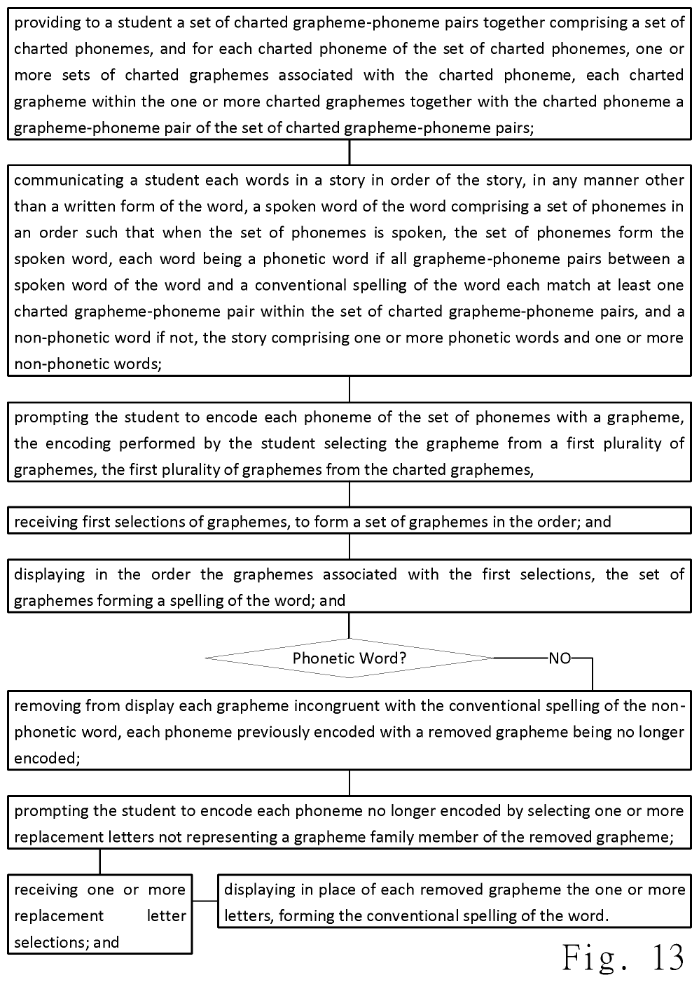

FIG. 13 illustrates an exemplary embodiment of teaching a student to write using a phonetic word distinction technique. The method can comprise the step of providing to a student a set of charted grapheme-phoneme pairs. The set of charted grapheme-phoneme pairs can comprise a set of charted phonemes, and for each charted phoneme of the set of charted phonemes, one or more sets of charted graphemes can be associated with the charted phoneme. Each charted grapheme can be within the one or more charted graphemes together with the charted phoneme a grapheme-phoneme pair of the set of charted grapheme-phoneme pairs. The method can also comprise the step of communicating to a student each word in a story in order of the story, in any manner other than a written form of the word. The spoken word of the word can comprise a set of phonemes in the order such that when the set of phonemes is spoken, the set of phonemes form the spoken word. Each of the word can be a phonetic word if all grapheme-phoneme pairs between a spoken word of the word and a conventional spelling of the word can each match at least one charted grapheme-phoneme pair within the set of charted grapheme-phoneme pairs, and a non-phonetic word if not. The story can comprise one or more of the phonetic words and one or more of the non-phonetic words. The method can also comprise the steps of prompting the student to encode each phoneme of the set of phonemes with a grapheme, receiving first selections of the graphemes to form a set of graphemes in the order, and displaying in the order the graphemes associated with the first selections. The set of graphemes forming a spelling of the word. The encoding performed by the student by selecting the grapheme from a first plurality of graphemes. The first plurality of graphemes can be from the charted graphemes. For the non-phonetic word spelled with an unconventional spelling using the first plurality of graphemes, the method can comprise the steps of removing from display each of the grapheme incongruent with the conventional spelling of the non-phonetic word. Each of the phonemes previously encoded with a removed grapheme being no longer encoded. Furthermore, for non-phonetic word, the method can also comprise the steps of prompting the student to encode each of the phoneme no longer encoded, by selecting one or more replacement letters not representing a grapheme family member of the removed grapheme, receiving the one or more replacement letter selections, and displaying in place of each of the removed grapheme the one or more letters, forming the conventional spelling of the word.

While reading routine 401 and writing routine 402 are disclosed independently within this disclosure, reading routine 401 and writing routine 402 can be intertwined in a number of ways. For example, in one embodiment, a student can be taught to read word 203 in a portion of reading routine 401, and before completing reading routine 401, pause reading routine, and start writing routine 402 to practice writing the same word 203. Similarly, once the student can leave writing routine 402, and continue reading routine 401. Further, such process can be done with an entire story 202 instead of with just one word 203.

In another embodiment, a student can be taught to read grapheme 206 within word 203 in a portion of reading routine, and before completing reading routine 401, pause reading routine 401, and start writing routine 402 to practice a different word 203 that comprises a same grapheme 206 as word 203 within reading routine 401. For example, in reading routine 401, the student may read “day” and then be asked to write the word “day”. This technique of having the student read and write the same language allow the student to make direct connections between two modalities of reading and writing and learning process is facilitated.

Operating system(s) can be stored in memory 101 and executable by processor 102. Other applications can be stored in memory 101 and executable by processor 102. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in memory 101 and can be executable by processor 102. In this respect, the term “executable” can mean a program file that is in a form that can ultimately be run by processor 102. Examples of executable programs can include a compiled program that can be translated into machine code in a format that can be loaded into a random access portion of memory 101 and run by processor 102, source code that can be expressed in proper format such as object code that is capable of being loaded into a random access portion of memory 101 and executed by processor 102, or source code that can be interpreted by another executable program to generate instructions in a random access portion of memory 101 to be executed by processor 102, etc. An executable program can be stored in any portion or component of memory 101.

Memory 101 can include both volatile and non-volatile memory and data storage components. Volatile components do not retain data values upon loss of power. Non-volatile components, on the other hand, retain data upon a loss of power. Thus, memory 101 can comprise, for example, random access memory (RAM), read-only memory (ROM), hard disk drives, solid-state drives, USB flash drives, memory cards accessed via a memory card reader, and/or any other memory component(s) known in the art. In addition, the RAM can comprise, for example, static random-access memory (SRAM), dynamic random-access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Processor 102 can represent multiple processors that operate in parallel processing circuits, respectively, or across one or more electronic devices 105 and/or server(s) 106.

Although learning application 103, and other various systems described herein can be embodied in software or code executed by general purpose hardware discussed above, learning application 103 can also be embodied in dedicated hardware or a combination of software/general purpose hardware and dedicated hardware. If embodied in dedicated hardware, each learning application 103 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIGS. 10, 11, 12, and 13 show the functionality and operation of an implementation of portions of learning application 103. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 102 in a computer system or other system. The machine code can be converted from the source code, etc. If embodied in hardware, each block can represent a circuit or a number of interconnected circuits to implement the specified logical function(s).

Although the flowchart of FIGS. 10, 11, 12, and 13 show a specific order of execution, the order of execution can differ from what is depicted, unless otherwise stated. For example, the order of execution of two or more blocks can be rearranged relative to the order shown. Also, two or more blocks shown in succession in flowchart of FIGS. 10, 11, 12, and 13 can be executed concurrently or with partial concurrence, unless otherwise stated. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including learning application 103, can be embodied in any computer-readable storage medium for use by or in connection with an instruction execution system such as, processor 102 in a computer system or other system. The logic can comprise statements including instructions and declarations that can be fetched from the computer-readable storage medium and executed by the instruction execution system.

In the context of the present disclosure, a “computer-readable storage medium” can be any non-transitory medium that can contain, store, or maintain the logic or application described herein for use by or in connection with the instruction execution system.

This above-description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. Accordingly, the claims appended hereto are not intended to be limited by the disclosed embodiments, but are to be accorded their widest scope consistent with the principles and features disclosed herein. In the appended claims, the terms “including” and “in which” are used as the plain-English equivalents of the respective terms “comprising” and “wherein.”

1. A method of teaching a student how to write using a phonetic word distinction technique comprising the steps of
providing to a student a set of charted grapheme-phoneme pairs together comprising
a set of charted phonemes, and
for each charted phoneme of said set of charted phonemes, one or more sets of charted graphemes associated with said charted phoneme, each charted grapheme within said one or more charted graphemes together with said charted phoneme a grapheme-phoneme pair of said set of charted grapheme-phoneme pairs;
communicating a student each words in a story in order of said story, in any manner other than a written form of said word, a spoken word of said word comprising a set of phonemes in an order such that when said set of phonemes is spoken, said set of phonemes form said spoken word, each said word being a phonetic word if all grapheme-phoneme pairs between a spoken word of said word and a conventional spelling of said word each match at least one charted grapheme-phoneme pair within said set of charted grapheme-phoneme pairs, and a non-phonetic word if not, said story comprising one or more said phonetic words and one or more said non-phonetic words;
prompting the student to encode each phoneme of said set of phonemes with a grapheme, said encoding performed by the student selecting said grapheme from a first plurality of graphemes, said first plurality of graphemes from said charted graphemes,
receiving first selections of said graphemes, to form a set of graphemes in said order;
displaying in said order said graphemes associated with said first selections, said set of graphemes forming a spelling of said word; and
for said non-phonetic word spelled with an unconventional spelling using said first plurality of graphemes:
removing from display each said grapheme incongruent with said conventional spelling of said non-phonetic word, each said phoneme previously encoded with a removed grapheme being no longer encoded,
prompting the student to encode each said phoneme no longer encoded by selecting one or more replacement letters not representing a grapheme family member of said removed grapheme,
receiving said one or more replacement letter selections, and
displaying in place of each said removed grapheme said one or more letters, forming said conventional spelling of said word.

2. The method of claim 1 further comprising the steps for said phonetic word,
removing from display each said charted grapheme incongruent with said conventional spelling of said word,
prompting the student to encode each said charted phoneme no longer encoded, by selecting a replacement charted grapheme from a second plurality of charted graphemes;
receiving a second selection of said replacement charted-grapheme for each said removed charted grapheme; and
displaying in place of each said removed charted grapheme said replacement charted grapheme, forming said conventional spelling of said word.

3. The method of claim 1 wherein communicating said word to the student comprises audibly communicating said word.

4. The method of claim 1 wherein communicating said word to the student comprises displaying a representative image of said word.

5. The method of claim 1 further comprising the step of displaying for each said word, prior to receiving said first selections, a set of generic symbols in said order, each generic symbol of said set of generic symbols representing one said phoneme from said set of phonemes.

6. The method of claim 1 wherein prompting the student to encode each said phoneme comprises audibly communicating each said phoneme to the student.

7. The method of claim 1 wherein prompting the student to encode each said phoneme comprises showing a representative image of each said phoneme to the student.

8. The method of claim 2 wherein displaying each said grapheme comprises, for each said grapheme, turning a card face up, said card comprising a face and a back, said face comprising said grapheme.

9. The method of claim 8 wherein each said back of said cards comprising a generic symbol.

10. The method of claim 1 wherein said first plurality of graphemes is associated with a first chart;

11. The method of claim 2 wherein said second plurality of graphemes is associated with a second chart.

12. A system for teaching a student how to write using a phonetic word distinction technique comprising
a memory comprising
a learning application, and
a data store comprising
a set of charted grapheme-phoneme pairs together comprising
a set of charted phonemes, and
for each charted phoneme of said set of charted phonemes, one or more sets of charted graphemes associated with said charted phoneme, each charted grapheme within said one or more charted graphemes together with said charted phoneme a grapheme-phoneme pair of said set of charted grapheme-phoneme pairs;
a story comprising a plurality of words, each word of said plurality of words being a phonetic word if all grapheme-phoneme pairs between a spoken word of said word and a conventional spelling of said word each match at least one charted grapheme-phoneme pair within said set of charted grapheme-phoneme pairs, and a non-phonetic word if not, said story comprising one or more said phonetic words and one or more said non-phonetic words;
a processor, that according to instructions from said learning application
communicates to a student each words in a story in order of said story, in any manner other than a written form of said word, a spoken word of said word comprising a set of phonemes in an order such that when said set of phonemes is spoken, said set of phonemes form said spoken word, each said word being a phonetic word if all grapheme-phoneme pairs between a spoken word of said word and a conventional spelling of said word each match at least one charted grapheme-phoneme pair within said set of charted grapheme-phoneme pairs, and a non-phonetic word if not, said story comprising one or more said phonetic words and one or more said non-phonetic words;
prompts the student to encode each phoneme of said set of phonemes with a grapheme, said encoding performed by the student selecting said grapheme from a first plurality of graphemes, said first plurality of graphemes from said charted graphemes,
receives first selections of said graphemes, to form a set of graphemes in said order;
and
displays in said order said graphemes associated with said first selections, said set of graphemes forming a spelling of said word; and
for said non-phonetic word spelled with an unconventional spelling using said first plurality of graphemes,
removes from display each said grapheme incongruent with said conventional spelling of said non-phonetic word, each said phoneme previously encoded with a removed grapheme being no longer encoded;
prompts the student to encode each said phoneme no longer encoded, by selecting one or more replacement letters not representing a grapheme family member of said removed grapheme;
receives said one or more replacement letter selections; and
displays in place of each said removed grapheme said one or more letters, forming said conventional spelling of said word.

13. The system of claim 11 further wherein
said processor further, according to instructions from said learning application, for
removes from display each said grapheme incongruent with said conventional spelling of said word, each said phoneme previously encoded with a removed grapheme being no longer encoded;
prompts the student to encode each said phoneme no longer encoded, by selecting a replacement grapheme from a second plurality of graphemes, each said replacement grapheme associated with a chart other than said first chart;
receives a second selection of said replacement grapheme for each said removed grapheme; and
displays in place of each said removed grapheme said replacement grapheme, forming said conventional spelling of said word.

14. The system of claim 11 wherein communicating said word to the student comprises audibly communicating said word through a speaker.

15. The system of claim 11 wherein communicating said word to the student comprises displaying a representative image of said word on a screen.

16. The system of claim 11 further comprising the step of displaying, prior to receiving first selections, a set of generic symbols in said order, each generic symbol of said set of generic symbols representing one said phoneme from said set of phonemes.

17. The system of claim 11 wherein prompting the student to encode each said phoneme comprises audibly communicating each said phoneme to the student using a speaker.

18. The system of claim 11 wherein prompting the student to encode each said phoneme comprises displaying a representative image of each said phoneme to the student on a screen.

19. A non-transitory computer readable storage medium having a computer readable program code embodied therein, wherein the computer readable program code is adapted to be executed to implement the method of claim 11.
